(19) United States
(12) Patent Application Publication
(10) Pub. No.: US 2023/0026748 A1
(43) Pub. Date: Jan. 26, 2023

(54) SYSTEMS, METHODS, STORAGE MEDIA, AND COMPUTING PLATFORMS FOR SCANNING ITEMS AT THE POINT OF MANUFACTURING

(71) Applicant: Printforia, Washougal, WA (US)

(72) Inventors: Robert George Boehm, JR., Portland, OR (US); Michael William Tanguay, Camas, WA (US); David McCalib, Hillsboro, OR (US)

(73) Assignee: Printforia, Washougal, WA (US)

(21) Appl. No.: 17/688,273

(22) Filed: Mar. 7, 2022

Related U.S. Application Data
(63) Continuation of application No. 16/938,021, filed on Jul. 24, 2020, now abandoned.
(60) Provisional application No. 63/029,356, filed on May 22, 2020.

(51) Int. Cl. G05B 19/402; D06P 5/24; D06P 5/30; G06T 7/00; G06T 7/80; G06T 7/70; G06K 9/62; G06T 3/60; G06T 5/50

(52) U.S. Cl. CPC G05B 19/402; D06P 5/003; D06P 5/30; G06T 7/001; G06T 7/80; G06T 7/70; G06K 9/6201; G06T 3/60; G06T 5/50; G06T 7/0004; G06T 2207/30144; D10B 2501/04; A62B 18/025

(57) ABSTRACT

Systems, methods, storage media, and computing platforms for scanning items at the point of manufacturing are disclosed. Exemplary implementations may: receive a first set of images of an item from a first set of camera sources; detect a code in the first set of images; combine, responsive to detecting the code, along a second axis perpendicular to the first axis, the first set of images into a first set of combined images; rotate parallel to the first axis; and combine along the first axis.

### CROSS-REFERENCE TO RELATED APPLICATIONS

The present application claims priority to Application No. 63/029,356 filed on May 22, 2020, the contents of which are incorporated herein by reference in their entirety.

### FIELD OF THE DISCLOSURE

The present disclosure relates to systems, methods, storage media, and computing platforms for scanning items at the point of manufacturing.

### BACKGROUND

Manufacturing many items requires a lot of bulky equipment and verifying the quality of the manufactured items is difficult.

### SUMMARY

One aspect of the present disclosure relates to a system configured for scanning items at the point of manufacturing. The system may include one or more hardware processors configured by machine-readable instructions. The processor(s) may be configured to receive a first set of images of an item from a first set of camera sources. The item may traverse beneath the first set of camera sources along a first axis. The processor(s) may be configured to detect a code in the first set of images. The code may have a unique item identifier. The processor(s) may be configured to combine, responsive to detecting the code, along a second axis perpendicular to the first axis, the first set of images into a first set of combined images. The processor(s) may be configured to rotate parallel to the first axis. Each of the combined images may be rotated into a first set of rotated images. The processor(s) may be configured to combine along the first axis. The first set of rotated images may rotate into a first partial item image.

Another aspect of the present disclosure relates to a method for scanning items at the point of manufacturing. The method may include receiving a first set of images of an item from a first set of camera sources. The item may traverse beneath the first set of camera sources along a first axis. The method may include detecting a code in the first set of images. The code may have a unique item identifier. The method may include combining, responsive to detecting the code, along a second axis perpendicular to the first axis, the first set of images into a first set of combined images. The method may include rotating parallel to the first axis. Each of the first set of combined images may be rotated into a first set of rotated images. The method may include combining along the first axis. The first set of rotated images may rotate into a first partial item image.

Yet another aspect of the present disclosure relates to a non-transient computer-readable storage medium having instructions embodied thereon, the instructions being executable by one or more processors to perform a method for scanning items at the point of manufacturing. The method may include receiving a first set of images of an item from a first set of camera sources. The item may traverse beneath the first set of camera sources along a first axis. The method may include detecting a code in the first set of images. The code may have a unique item identifier. The method may include combining, responsive to detecting the code, along a second axis perpendicular to the first axis, the first set of images into a first set of combined images. The method may include rotating parallel to the first axis. Each of the first set of combined images may be rotated into a first set of rotated images. The method may include combining along the first axis. The first set of rotated images may combine into a first partial item image.

Still another aspect of the present disclosure relates to a system configured for scanning items at the point of manufacturing. The system may include means for receiving a first set of images of an item from a first set of camera sources. The item may traverse beneath the first set of camera sources along a first axis. The system may include means for detecting a code in the first set of images. The code may have a unique item identifier. The system may include means for combining, responsive to detecting the code, along a second axis perpendicular to the first axis, the first set of images into a first set of combined images. The system may include means for rotating parallel to the first axis. Each of the combined images may be rotated into a first set of rotated images. The system may include means for combining along the first axis. The first set of rotated images may combine into a first partial item image.

Even another aspect of the present disclosure relates to a computing platform configured for scanning items at the point of manufacturing. The computing platform may include a non-transient computer-readable storage medium having executable instructions embodied thereon. The computing platform may include one or more hardware processors configured to execute the instructions. The processor(s) may execute the instructions to receive a first set of images of an item from a first set of camera sources. The item may traverse beneath the first set of camera sources along a first axis. The processor(s) may execute the instructions to detect a code in the first set of images. The code may have a unique item identifier. The processor(s) may execute the instructions to combine, responsive to detecting the code, along a second axis perpendicular to the first axis, the first set of images into a first set of combined images. The processor(s) may execute the instructions to rotate parallel to the first axis. Each of the combined images may be rotated into a first set of rotated images. The processor(s) may execute the instructions to combine along the first axis. The first set of rotated images may combine into a first partial item image.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 depicts an embodiment of a system for manufacturing and scanning items.

FIG. 2 depicts an embodiment of the system for scanning items at the point of manufacturing, in accordance with one or more implementations.

FIG. 3 depicts an embodiment of a quality controller for determining whether items satisfy quality thresholds.

FIG. 4 depicts an embodiment of a lateral transport mechanism for receiving items and carrying items into an inspection region.

FIG. 5 depicts an embodiment of the computing platforms for scanning items with multiple computing platforms and cameras.

FIG. 6 depicts an embodiment of the computing platform for analyzing items.

FIG. 7 depicts an embodiment of the camera placement for scanning items in the inspection region.

FIG. 8 depicts an embodiment of a camera view of the inspection region for calibrating the cameras.

FIG. 9 depicts an embodiment of an item traversing the lateral transport mechanism for analysis in the inspection region.

FIG. 10 depicts an embodiment of spot intensity analysis for determining a lateral transport mechanism speed.

FIG. 11 depicts an embodiment of a horizontal axis combiner for combining images as a fade.

FIG. 12 depicts an embodiment of a horizontal axis combiner for combining images as a discrete seam.

FIG. 13 depicts an embodiment of a horizontal axis combiner for combining images of nonplanar items.

FIG. 14 depicts an embodiment of an image buffer for combining a stack of horizontal images into a partial item image.

FIG. 15 depicts an embodiment of an image histogram for analyzing the parameters of the image.

FIG. 16 depicts an embodiment of the system for manufacturing and scanning garments.

FIG. 17A depicts an embodiment of a loader for loading garments at the point of manufacturing.

FIG. 17B depicts an embodiment of a platen receiving a grid for aligning a garment.

FIG. 17C depicts an embodiment of the grid having a collar line for aligning garments based on collar.

FIG. 17D depicts an embodiment of a sensor for projecting the grid on the platen.

FIG. 18A depicts an embodiment of the grid overlaid on the item disposed on the platen.

FIG. 18B depicts an embodiment of the grid overlaid on the shirt disposed on the platen.

FIG. 19A depicts an embodiment of the grid overlaid on the item.

FIG. 19B depicts an embodiment of the grid overlaid on the shirt.

FIG. 20A depicts an embodiment of the lid closing over the platen.

FIG. 20B depicts an embodiment of the lid closing over the platen having the item.

FIG. 20C depicts an embodiment of the lid closing over the platen having the shirt.

FIG. 21A depicts an embodiment of the lid closed over the platen.

FIG. 21B depicts an embodiment of the lid closed over the platen having the item.

FIG. 21C depicts an embodiment of the lid closed over the platen having the shirt.

FIG. 22 depicts an embodiment of the lateral transport mechanism carrying garments for analysis in the inspection region.

FIG. 23 depicts an embodiment of a flow of the computing platform for analyzing shirts.

FIG. 24 depicts an embodiment of the image buffer for analyzing horizontal portions of the garments.

FIG. 25 depicts an embodiment of an image histogram for indicating a parameters of the garment image.

FIG. 26 depicts an embodiment of a comparison for identifying defects in the garment based on a reference design.

FIG. 27 depicts an embodiment of a comparison for indicating differences between the garments image and the reference image.

FIG. 28 depicts an embodiment of a difference highlighter highlighting differences between the reference image and the captured image.

FIG. 29 depicts an embodiment of the system for manufacturing masks.

FIG. 30 depicts an embodiment of a container for containing a manufacturer of masks.

FIG. 31 depicts an enclosure of the container for containing the system configured for manufacturing masks.

FIG. 32 depicts a cross section of containers for containing manufacturers of masks.

FIG. 33 depicts a method for scanning items at the point of manufacturing, in accordance with one or more implementations.

### DETAILED DESCRIPTION

Customers can order a variety of general items or custom items, but warehouses might not have all the items in stock for fulfillment. Therefore, entities can manufacture the items to fulfill the order. Manufacturing the items for the order can reduce the delays and uncertainties from stocking warehouses and managing supply chains. However, manufactured items can have different qualities that may or may not satisfy quality standards. A quality controller can evaluate the quality of the manufactured items at the point of manufacturing to speed up fulfillment and manage the quality of orders. The quality controller can facilitate the fulfillment of items that satisfy quality standards, while items that do not satisfy quality standards can be re-manufactured while adjusting the manufacturing process to improve the quality of items manufactured.

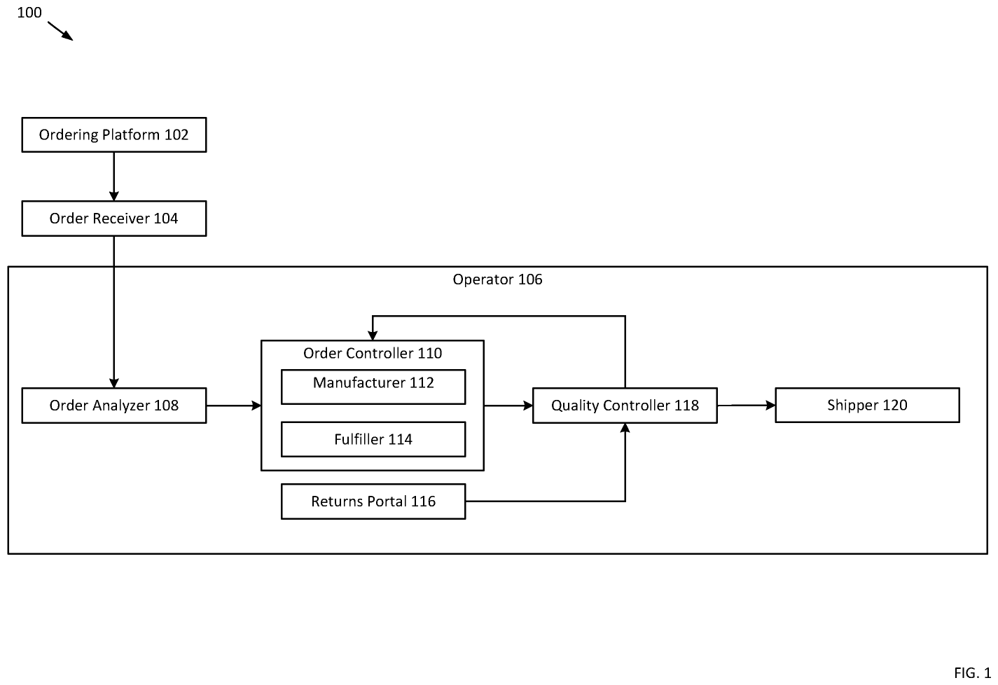

FIG. 1 depicts an embodiment of a manufacturing system 100 for managing the manufacturing and fulfillment of items. The system 100 can include an ordering platform layer 102. The ordering platform layer 102 can submit orders to manufacture or fulfill the items. The system can include an order receiver layer 104. The order receiver layer 104 can receive the submitted orders, verify the orders, validate the orders, and forward the orders to an operator layer 106.

Still referring to FIG. 1 and in further detail, the operator layer 106 can include an order analyzer 108 converting the specifications from the order received by the order receiver layer 104 to a standardized order, and transmit the standardized order to an order controller 110. The order controller 110 can manage the manufacturing of the items by a manufacturer 112 and fulfill the items by a fulfiller 114. The operator layer 106 can include a returns portal 116, which can receive a return request for an item. The operator layer 106 can include a quality controller 118 determining whether the manufactured or the fulfilled items satisfy quality thresholds. The operator layer 106 can include a shipper 120, which can manage an interface between the operator layer 106 and shippers of the orders and the returns.

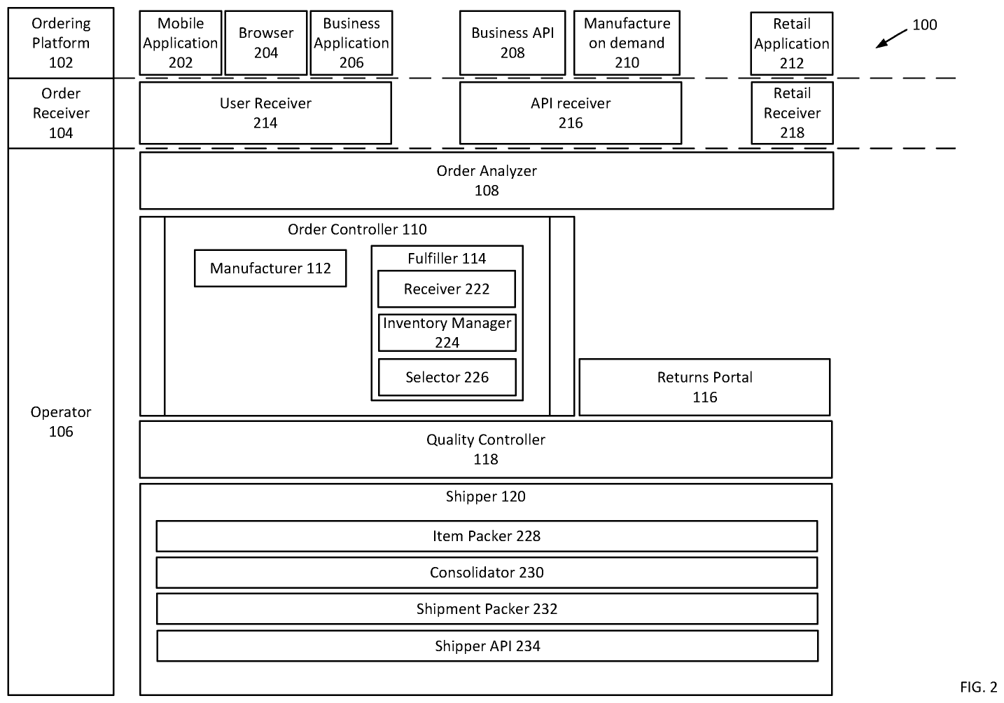

Now referring to FIG. 2, depicted in further detail is an embodiment of the manufacturing system 100 for manufacturing items. The manufacturing system 100 can include the ordering platform layer 102, order receiver layer 104, and operator layer 106. As shown in FIG. 2, the ordering platform layer 102 may be provided as a mobile application 202, a browser-based solution 204, a business application 206, a business API 208, a manufacture on demand API 210, and a retail application 212. The ordering platform layer 102 can detect orders for items. The orders can include item specifications such as item type, item quantity, and item design. In some embodiments, the orders may indicate whether the items need to be manufacturer or fulfilled.

As shown in FIG. 2, the ordering platform layer 102 may use a mobile application 202 for detecting orders. Mobile application 202 can include an application operating natively on Android, iOS, WatchOS, Linux, or other operating system. Mobile application 202 may execute on a wide variety of mobile devices, such as a personal digital assistant, phone, tablet, mobile game device, watch, or other wearable computing device. Mobile application 202 may receive order information such as item type, item quantity, and item design. Mobile device may communicate with the order receiver layer 104 via any suitable network, such a Wi-Fi, Bluetooth, or cellular networks, such as GSM, CDMA, 4G, LTE, or 5G.

The ordering platform layer 102 may use, alternatively, a browser-based solution 204 for submitting orders. A user of the browser-based solution 204 can select attributes of the order such as a type of item, the item quantity, and item design. For instance, a user may order five t-shirts having a monster design. The browser-based solution 204 can receive order information such as item type, item quantity, and item design. The browser-based solution 204 can be an application running in an applet, a flash player, or in a HTML-based application. Browser-based solution 204 may execute on a wide variety of devices, such as a laptop computers, desktop computers, game consoles, set-top boxes or mobile devices capable of executing browser such as personal digital assistants, phones, and tablets. The browser-based solution 204 can communicate with the ordering platform layer 102 via browser networking protocols.

The ordering platform layer 102 may use, alternatively, a business application 206 for submitting orders. The business application 206 can include a software or computer program submitting the orders by a business. The business application 206 can operate natively on Android, iOS, Windows, Linux, or other operating system. The business application 206 may execute on a wide variety of business devices, such as a manufacturing computer, a production computer, a sales computer, or an inventory computer. The computers can communicate with the order receiver layer 104 via any suitable network, such a Wi-Fi, Bluetooth, or cellular networks, such as GSM, CDMA, 4G, LTE, or 5G. The business application 206 may receive order information such as item type, item quantity, and item design. Users of the business application 206 can select attributes of the order such as a type of item, the item quantity, and item design. For instance, the user can select a truckload of t-shirts having a particular logo.

The ordering platform layer 102 may use, alternatively, a business API 208 for submitting orders. The business API 208 can include an application-programming interface facilitating the submission of the orders by a business entity into the system 100. In some embodiments, the business API 208 refers to a business application-programming interface. The business API 208 can define interactions between multiple software intermediaries operating between a business and the order receiver layer 104. The business API 208 can define calls, requests, and conventions between the multiple software intermediaries. The business API 208 can connect to the order receiver layer 104 via a networking or API portal compatible with Android, iOS, Windows, Linux, zOS, an IBM mainframe, POSIX, or other operating system designed for an API implementation. Business API 208 may connect a wide variety of business devices, such as a server, a production server, a sales server, or an inventory computer. The computers can communicate with the order receiver layer 104 via any suitable networking protocol, such as a remote API, a web API, or an API software library. Business API 208 may receive order information such as item type, item quantity, and item design. Users of the business API 208 can transmit attributes of the order such as a type of item, the item quantity, and item design. For instance, the business can transmit orders defining a t-shirt size and design from their business computers to the order receiver layer 104 via the business API 208.

The ordering platform layer 102 may use, alternatively, a manufacture on demand API 210 for submitting orders. The manufacture on demand API 210 can include a software application submitting the orders responsive to receiving a request for the items. The manufacture on demand API 210 can include an application-programming interface facilitating the submission of the orders by a manufacturing entity ported into the system 100. The manufacturer may transmit attributes of the manufacturing order specifications such as the dimensions, materials, quantity, and reference designs. The manufacturing devices may transmit, via the manufacturing on demand API 210, manufacturing information such as item type, item quantity, and item design. For instance, the manufacturer can transmit, via the manufacture on demand API 210, a manufacturing order for fifty masks having a certain polymer material with a reference design achieving a predetermined filtration rate. The manufacture on demand API 210 allows the system 100 to manufacturer items specifically for an order rather than having to stock items and await the order. In some embodiments, the manufacture on demand API 210 refers to a manufacturing application-programming interface. The manufacture on demand API 210 can define interactions between multiple software intermediaries operating between a manufacturer and the order receiver layer 104. The manufacture on demand API 210 can define calls, requests, and conventions between the multiple software intermediaries. The manufacture on demand API 210 can connect to the order receiver layer 104 via a networking or API portal compatible with Android, iOS, Windows, Linux, zOS, an IBM mainframe, POSIX, or other operating system designed for an API implementation. The manufacture on demand API 210 may connect a wide variety of manufacturing devices, such as a server, a production server, a materials server, or an assembly controller. The manufacturing devices can communicate with the order receiver layer 104 via any suitable networking protocol, such as a remote API, a web API, or an API software library.

The ordering platform layer 102 may use, alternatively, a retail application 212 for submitting orders. The retail application 212 can include a software or computer program submitting the orders by a business. The retail application 212 can operate natively on Android, iOS, Windows, Linux, or other operating system. The retail application 212 may execute on a wide variety of retail devices, such as a checkout device, an inventory device, or a smart shopping cart. The retail devices can interact with customers in a store or a mall. The customers may select items on the retail devices. The retail application 212 can also allow the customer to place an order. For instance, the customer can request a medium shirt, and the retail application 212 can submit an order to the order receiver layer 104 specifying a medium shirt having design characteristics specified in the order. The retail devices may also automatically submit replenishment orders to the order receiver layer 104. For instance, if the customer places an item into their smart shopping cart or checks the item out at via the checkout device, the retail application 212 may transmit, to the order receiver layer 104, a replenishment request of the item. The retail application 212 can transmit the attributes of the ordered item such as a type, quantity, and design. For instance, the retail application 212 can transmit a replenishment request for a small shirt responsive to a customer buying a small shirt. The devices can communicate with the order receiver layer 104 via any suitable network, such a Wi-Fi, Bluetooth, or cellular networks, such as GSM, CDMA, 4G, LTE, or 5G.

Still referring to FIG. 2, depicted in further detail is order receiver layer 104 of the manufacturing system 100. As shown in FIG. 2, the order receiver layer 104 can include a user receiver 214, an API receiver 216, and a retail receiver 218. The user receiver 214 can receive the orders from the mobile application 202, the browser-based solution 204, and the business application 206. The user receiver 214 can forward the orders to the operator layer 106. The user receiver 214 can include an application-programming interface facilitating the exchange of the orders between the ordering platform layer 102 and the operator layer 106. In some embodiments, the user receiver 214 refers to a business application-programming interface. The user receiver 214 can define interactions between multiple software intermediaries operating between the ordering platform layer 102 and the operator layer 106. The user receiver 214 can define calls, requests, and conventions between the multiple software intermediaries. The user receiver 214 can facilitate a connection between the order receiver layer 104 and the operator layer 106 via a networking or API portal compatible with Android, iOS, Windows, Linux, zOS, an IBM mainframe, POSIX, or other operating system designed for an API implementation.

The order receiver layer 104 may use, alternatively, the API receiver 216 to receive the orders from the business API 208 and the manufacture on demand API 210. The API receiver 216 can forward the orders to the operator layer 106. The API receiver 216 can include an application-programming interface facilitating the exchange of the orders between the ordering platform layer 102 and the operator layer 106. In some embodiments, the API receiver 216 refers to a business application-programming interface. The API receiver 216 can define interactions between multiple software intermediaries operating between the ordering platform layer 102 and the operator layer 106. The API receiver 216 can define calls, requests, and conventions between the multiple software intermediaries. The API receiver 216 can facilitate a connection between the order receiver layer 104 and the operator layer 106 via a networking or API portal compatible with Android, iOS, Windows, Linux, zOS, an IBM mainframe, POSIX, or other operating system designed for an API implementation.

The order receiver layer 104 may use, alternatively, the retail receiver 218 to receive orders from the retail application 212. The retail receiver 218 can forward the orders to the operator layer 106. The retail receiver 218 can include an application-programming interface facilitating the exchange of the orders between the ordering platform layer 102 and the operator layer 106. In some embodiments, the retail receiver 218 refers to a business application-programming interface. The retail receiver 218 can define interactions between multiple software intermediaries operating between the ordering platform layer 102 and the operator layer 106. The retail receiver 218 can define calls, requests, and conventions between the multiple software intermediaries. The retail receiver 218 can facilitate a connection between the order receiver layer 104 and the operator layer 106 via a networking or API portal compatible with Android, iOS, Windows, Linux, zOS, an IBM mainframe, POSIX, or other operating system designed for an API implementation.

Still referring to FIG. 2, depicted in further detail is operator layer 106 of the manufacturing system 100. As shown in FIG. 2, the operator layer 106 can include the order analyzer 108, the order controller 110, the returns portal 116, the quality controller 118, and the shipper 120. The order analyzer 108 can receive order specifications from the order receiver layer 104. The order analyzer 108 can determine if the order controller 110 can fulfill or manufacture the order specifications from the order receiver layer 104. For instance, the order analyzer can determine that the order contains an offensive logo, and thus reject the order. The order analyzer 108 can also determine if the order is compliant with regulations. For instance, if the order contains a request to manufacture illegal weapons, then the order analyzer 108 can reject the order. The order analyzer 108 can transmit the rejected order sent back to the ordering platform layer 102 via the order receiver layer 104. The order analyzer 108 can also verify the price of the order. For instance, the order analyzer 108 can verify that the order received from the retail application 212 reflects the most updated pricing scheme. The order analyzer can also convert the specifications from the order received by the order receiver layer 104 to a standardized order, and transmit the standardized order to an order controller 110. For instance, the order analyzer 108 may receive, from the order receiver layer 104, a picture file having a design for manufacturing. The order analyzer 108 may compress the picture file using lossless compression for high quality manufacturing, or the order analyzer 108 may compress the picture file using lossy compression for lower quality manufacturing.

Still referring to FIG. 2, depicted in further detail is operator layer 106 of the manufacturing system 100. As shown in FIG. 2, the order controller 110 can include the manufacturer 112 and the fulfiller 114. The order controller 110 can control the manufacturing or fulfillment of the items in the orders received from the order analyzer 108. The order controller 110 can determine whether to manufacture the items by a manufacturer 112 or fulfill the items by a fulfiller 114. For instance, the fulfiller 114 can fulfill items that are in stock, while the manufacturer 112 can manufacture items that are out of stock.

Still referring to FIG. 2 and in further detail, the manufacturer 112 can manufacture items. The manufacturer 112 can also remanufacture items based on receiving a remanufacture request. For instance, the manufacturer 112 can receive information from the quality controller 118 about defects in manufactured items and use that information to adjust the remanufacture the item. The manufacturer 112 can also manufacture packing materials for packing the item.

Still referring to FIG. 2, depicted in further detail is the fulfiller 114, which can fulfill orders with items that are in stock. The fulfiller 114 can include a receiver 222 receiving items for fulfillment from a warehouse or other supply source. The fulfiller 114 can include an inventory manager 224 managing the inventory of the items. The inventory manager 224 can track the location of the items in a warehouse. The fulfiller 114 can include a selector 226 selecting the items requested by the orders. The selector 226 can select the items from the inventory manager 224. The selector 226 can select items for fulfillment. Once the order controller 110 selects or manufacturers the item, the order controller 110 forwards the item to the quality controller 118 to determine whether the item has any defects.

Still referring to FIG. 2, depicted in further detail is the receiver 222. The receiver 222 can receive items for fulfillment. The receiver 222 can receive items from a supplier. The receiver 222 can receive items from the manufacturer. For instance, the manufacturer 112 can produce items in anticipation of orders. The receiver 222 can then receive the items made in anticipation of the order. The receiver 222 can forward the received items to the inventory manager 224.

Still referring to FIG. 2, depicted in further detail is the inventory manager 224, which track the items available for fulfillment by the fulfiller 114. The inventory manager 224 can generate an inventory status indicating how many of an item can be fulfilled. The inventory manager 224 can generate the inventory status responsive to an inquiry from the order controller 110. For instance, the order controller 110 may want to satisfy an order with two items. The order controller 110 may query the inventory manager 224 to determine if the items are available for fulfillment. The inventory status will indicate which items are available. The inventory status may say that one item is available. Responsive to the inventory status, the order controller 110 can have the fulfiller 114 fulfill one item and the manufacturer 112 produce the other item.

Still referring to FIG. 2, depicted in further detail is the selector 226, which can select the item for fulfillment. The selector 226 can select the item responsive to a request from the order controller 110 for an item. For instance, the selector 226 can select the item from a warehouse. The selector 226 can be an automated robot that identifies and selects the item in a warehouse. The selector 226 can be a notification device that notifies an order picker to get the item.

Still referring to FIG. 2 and in further detail, the returns portal 116 can receive a return request for an item. For items that were fulfilled from the warehouse, the returns portal 116 communicates with inventory manager 224 to reflect the return of the item into inventory. If the return request indicates a request to remanufacture the item, the returns portal 116 can forward the remanufacture request to the order controller 110. The returns portal 116 can also receive returned items and forward the returned items to the quality controller 118 for analysis in order to detect defects in the returned item.

Still referring to FIG. 2 and in further detail, the quality controller 118 can determine whether the manufactured item, the fulfilled items, or the returned item satisfy quality thresholds. The quality controller 118 can analyze or scan the items. The quality controller 118 can compare the selected items to an ideal item. The ideal item can include the design specifications of the item. The quality controller 118 can determine whether the items selected for fulfillment satisfy the specifications of the ordered item. The quality controller 118 can allow the fulfillment of the items that satisfy the specifications of the ordered item. The quality controller 118 can forward information about defects to the order controller 110 to adjust the manufacturing and fulfillment of orders. For instance, the quality controller 118 can transmit manufacturing feedback to the manufacturer 112. The feedback can specify issues with the manufacture materials. The quality controller 118 can determine whether the item satisfies a quality threshold. The quality threshold can indicate that the item satisfies the specifications of the ordered item or that the manufacturer 112 can remanufacture the item to satisfy the specifications of the ordered item. Based on the quality threshold, the quality controller 118 can also request the fulfiller 114 to select another item to fulfill the order. The quality controller 118 can forward items that satisfy the quality thresholds to the shipper 120, or forward items not satisfying quality thresholds to the order controller 110. The quality controller 118 can forward items without defects to the fulfiller 114. The shipper 120 can receive items forwarded by the quality controller 118, and ship the items with a variety of shipping carriers.

Still referring to FIG. 2 and in further detail, the shipper 120 can manage an interface between the operator layer 106 and shippers of the orders and returns. The shipper 120 can transmit shipping information about orders and returns. The shipper 120 can include an item packer 228 packing the selected item. The shipper 120 can include a consolidator 230 consolidating several packed items into a shipment. The shipper 120 can include a shipment packer 232 packing the packed items into a packed shipment. The shipper 120 can include a shipper API 234 for shipping the packed order.

Still referring to FIG. 2 and in further detail, the item packer 228 can pack manufactured items or fulfilled items. The item packer 228 can pack items based on the specifications of the order received by the order analyzer 108. For instance, based on the specifications, the item packer 228 can pack the item with bubble wrap or gift-wrap. The item packer 228 can receive and use packing materials from the fulfiller 114 or manufactured packing materials from the manufacturer 112.

Still referring to FIG. 2 and in further detail, the consolidator 230 can consolidate several packed items into bulk packaging. The consolidator 230 can bulk pack all the items based on the specifications of the order received by the order analyzer 108. For instance, based on the specifications, the consolidator 230 can pack all the items in an interconnected roll. The consolidator 230 can receive and use packing materials from the fulfiller 114 or manufactured packing materials from the manufacturer 112. The consolidator 230 can also select appropriate materials for bulk packaging the items. The consolidator 230 can receive, from the order controller 110, specifications for which packing materials to use. For instance, the consolidator 230 can receive a request for interconnected bags of items, or an adhesive to hold the items together until the user tears them away. The consolidator 230 can determine the appropriate packing material based on the weight and shape of the item. For instance, the consolidator 230 can determine, based on the item being light and made out of fabric, that the items can be stuck together. Items are inappropriately packed may break and be returned by the customers.

Still referring to FIG. 2 and in further detail, the shipment packer 232 can consolidate the item or the bulk items into a shipment. The shipment packer 232 can pack all the items based on the specifications of the order received by the order analyzer 108. For instance, based on the specifications, the shipment packer 232 can pack all the items in a box or on a pallet. The shipment packer 232 can receive and use packing materials from the fulfiller 114 or manufactured packing materials from the manufacturer 112. The shipment packer 232 can also select appropriate materials for shipment packaging. The shipment packer 232 can receive, from the order controller 110, specifications for which packing materials to use. For instance, the shipment packer 232 can receive a request for a pallet, or a large box to hold the items. The shipment packer 232 can determine the appropriate packing material based on the weight and shape of the item. For instance, the shipment packer 232 can determine, based on the items being light and fragile, that the items can be in a box. Alternatively, the shipment packer 232 can pack sturdy items on a shrink-wrapped pallet. Items are inappropriately packed may break and be returned by the customers.

Still referring to FIG. 2 and in further detail, the shipper API 234 can ship the items via a shipping carrier. The shipper API 234 can transmit shipping information about the order to the shipping company. The shipping information can contain the weight, the dimensions, and the type of shipment. For instance, the shipping information can include that the shipment weighs 100 lb., has dimensions of 5 ft.×5 ft.×5 ft., and is on a pallet. The shipper API 234 can identify and select a shipment carrier based on the shipping information and the order specifications received from the order analyzer 108. For instance, the order analyzer 108 may specify that the customer is price sensitive, so the shipper API 234 may select the cheapest shipping carrier. Alternatively, the order analyzer 108 may specify that the customer requested rush shipping, so the shipper API 234 may select the shipping carrier offering the fastest shipping speed.

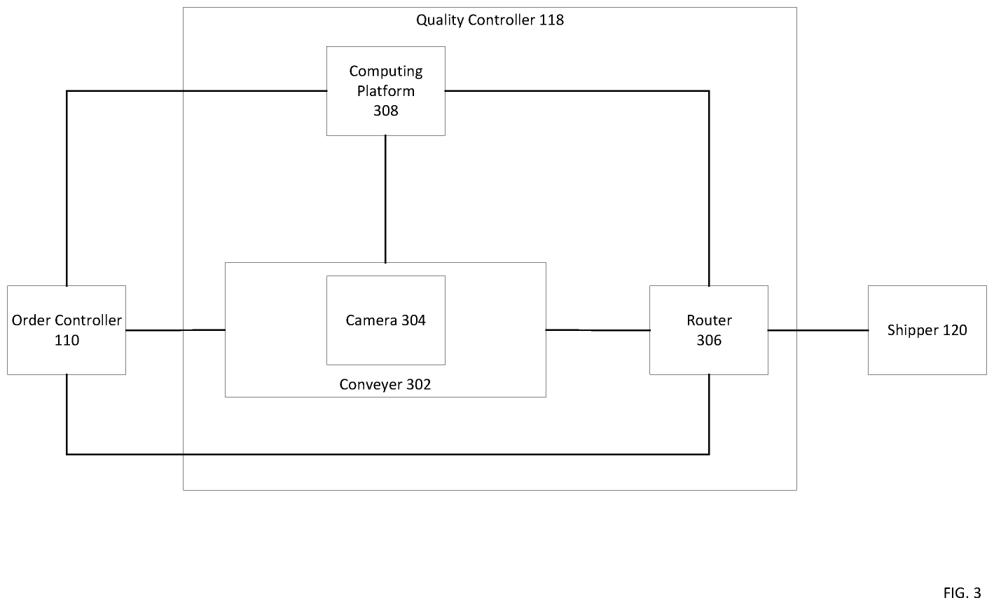

Now referring to FIG. 3, depicted in further detail is an embodiment of the quality controller 118 for determining whether the manufactured items, the fulfilled items, or the returned items satisfy quality thresholds. The quality controller 118 can include a lateral transport mechanism 302, which can receive the items from the manufacturer 112, the fulfiller 114, or the returns portal 116. In some embodiments, the lateral transport mechanism 302 is a conveyer, a conveyer mat, or a conveyer belt. The quality controller 118 can also include a camera 304, which can obtain images of the item for analysis by the computing platform 308. The quality controller 118 can also include a router 306, which can route items to the shipper 120, for further inspection, or back to the order controller 110. The quality controller 118 can include a computing platform 308, which can be software or hardware that receives and analyzes data corresponding to the items to determine whether the items satisfy quality thresholds.

Still referring to FIG. 3 and in further detail, the lateral transport mechanism 302 can receive the items from the manufacturer 112, the fulfiller 114, or the returns portal 116. The lateral transport mechanism 302 can be a moving mat or item holder. The mat can be made of rubber or other material providing sufficient friction between the mat and the item such the item moves with the mat. The item holder can be a lever, a slot, or an arm that positions the item. The lateral transport mechanism 302 can include a lateral transport mechanism communications transmitter (not shown) to communicate with the computing platform 308. The lateral transport mechanism 302 can move at a preset speed. The lateral transport mechanism 302 can adjust the preset speed based on a control signal from the computing platform 308. The lateral transport mechanism 302 can carry the item to the router 306. The lateral transport mechanism 302 can carry the item under a camera 304.

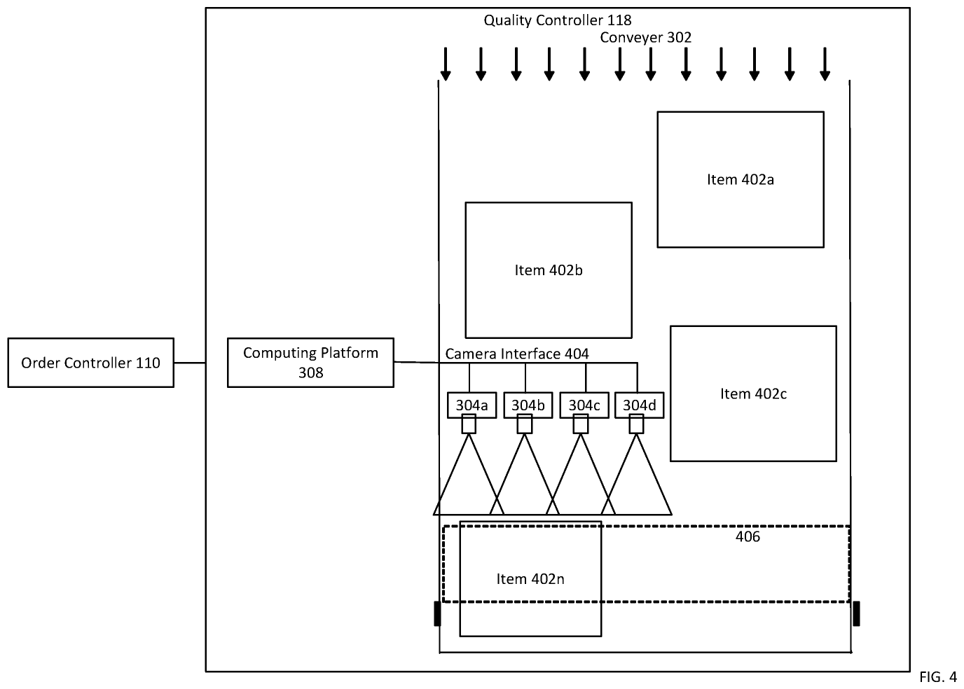

Now referring to FIG. 4, depicted in further detail is an embodiment of the lateral transport mechanism 302 for receiving items carrying items into an inspection region. The lateral transport mechanism 302 can include items 402a-402n (generally referred to as item 402) from the manufacturer 112, the fulfiller 114 or the returns portal 116. As shown in FIG. 4, the lateral transport mechanism 302 includes cameras 304a-304d (generally referred to as camera 304) communicating with the computing platform 308 via camera interface 404. Although four cameras are in FIG. 4, any number of cameras can be part of the quality controller 118. In some instances, the quality controller 118 can include more than four cameras and those instances are described in detail below. The lateral transport mechanism 302 can include an inspection region 406 where the camera 304 can image the item 402.

Still referring to FIG. 4 and in further detail, the item 402 arrives from the manufacturer 112, the fulfiller 114, or the returns portal 116. The lateral transport mechanism 302 can carry the item 402 under the cameras 304. The item 402 can be a garment, a device, a book, or any other item. In some embodiments, the item 402 travels beneath the cameras 304 along an axis parallel to the direction of travel of the lateral transport mechanism 302. The camera 304 can obtain images of the items 402 for analysis by the computing platform 308. Camera 304 can image the item 402 in the inspection region 406. The inspection region 406 can be a zone on the lateral transport mechanism 302. The inspection region 406 can include visual markers. The camera 304 can obtain images responsive to a camera signal from the computing platform 308. In other instances, the cameras 304 are continuously sending images from the inspection region 406 and the computing platform 308 detects when an image includes an image of an item. The camera 304 can include a wide variety of cameras such as digital cameras, professional video cameras, industrial cameras, camcorders, action cameras, remote cameras, pan-tilt-zoom cameras, and webcams. The camera 304 may be part of a wide variety of devices, such as a robotic arm, a stand, a drone, or other industrial device. The camera 304 may capture image information such as location, shutter speed, ISO, and aperture. The camera 304 may include a wide variety of image sensor elements, such as 5 megapixels (MP), 10 MP, 13 MP, or 100 MP. The camera 304 can also include a motion sensor, a location sensor, a temperature sensor, or a position sensor. The camera 304 can include a wide variety of zoom lenses having a wide variety of lens elements of varying focal lengths. Similarly, the cameras 304 can have a wide variety of image sensor formats, such as ⅓″, 1/2.5″, 1/1.8″, 4/3″, 35 mm full frame, or any other format.

Still referring to FIG. 4 and in further detail, the camera interface 404 between the camera 304 and the computing platform 308 can be a wireless or wired connection. The camera interface 404 can communicate with the computing platform 308 using an API. The camera interface 404 can allow multiple cameras with varying specifications and bit streams communicate with the computing platform 308. The camera interface 404 can support varying refresh rates and qualities of image streams, such as 60 Hz, 120 Hz, 1080p, or 4k. In some embodiments, the camera interface 404 transmits 1 frame per second to the computing platform 308.

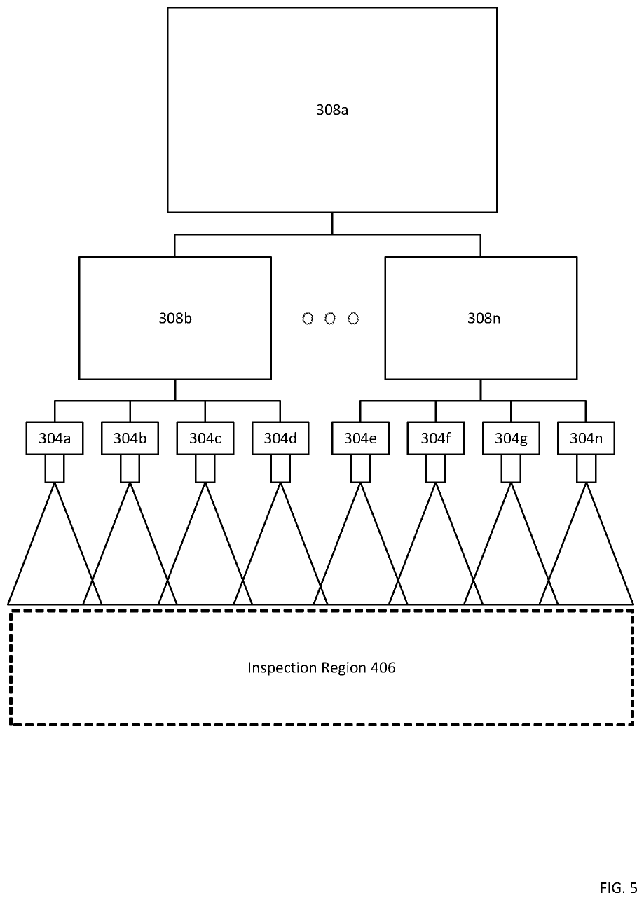

Now referring to FIG. 5, depicted is an embodiment of the computing platforms for scanning items with multiple computing platforms 308a-308n and cameras 304a-304n. The cameras and computing platforms can scale with the inspection region 406. For instance, if the inspection region 406 increases in size, then additional cameras can inspect the inspection region 406. Additional computing platforms can receive image streams from the additional cameras. The additional computing platforms can consolidate the image streams and transmit them to computing platforms that consolidate the consolidated image streams. The computing platform 308 can consolidate image streams from the cameras or from other computing platforms. For instance, as shown in FIG. 5 cameras 304a-304n images the inspection region 406. A first camera quartet 304a-304d images a section of the inspection region 406 and transmits the images to the computing platform 308b. A second camera quartet 304e-304n can image another section of the inspection region 406 and transmit the images to the computing platform 308n. Computing platform 308b and computing platform 308n can each consolidate the image stream from their camera quartet and transmit the consolidated image stream to computing platform 308a. The computing platform 308a can consolidate the consolidated image streams from camera 304b and camera 304n into an image stream of the inspection region 406.

Referring back to FIG. 3 and in further detail, the router 306 can route items to the shipper 120 for shipping, or back to the order controller 110 for further inspection or remanufacturing. The router 306 can communicate with the computing platform 308. The router 306 can route the items based on a routing signal from the computing platform 308. The router 306 can couple to the lateral transport mechanism 302.

Still referring to FIG. 3 and in further detail, the computing platform 308 can be software or hardware that receives and analyzes data corresponding to the items to determine whether the items satisfy quality thresholds. The computing platform 308 can be an embedded computer. The computing platform 308 can include a central processing unit or a graphical processing unit. The computing platform 308 can be a server. The computing platform 308 can include artificial intelligence or machine learning. The computing platform 308 can classify the items. The computing platform 308 can identify defects in the items. The computing platform 308 can communicate with the lateral transport mechanism 302. The computing platform 308 can control the speed of the lateral transport mechanism 302. The computing platform 308 can communicate with the camera 304. The computing platform 308 can communicate with any number of cameras. The computing platform 308 can control the image capturing of the camera 304. The computing platform 308 can receive image data from the camera 304. The computing platform 308 can communicate with the router 306. The computing platform 308 can control routing of the item by the lateral transport mechanism 302.

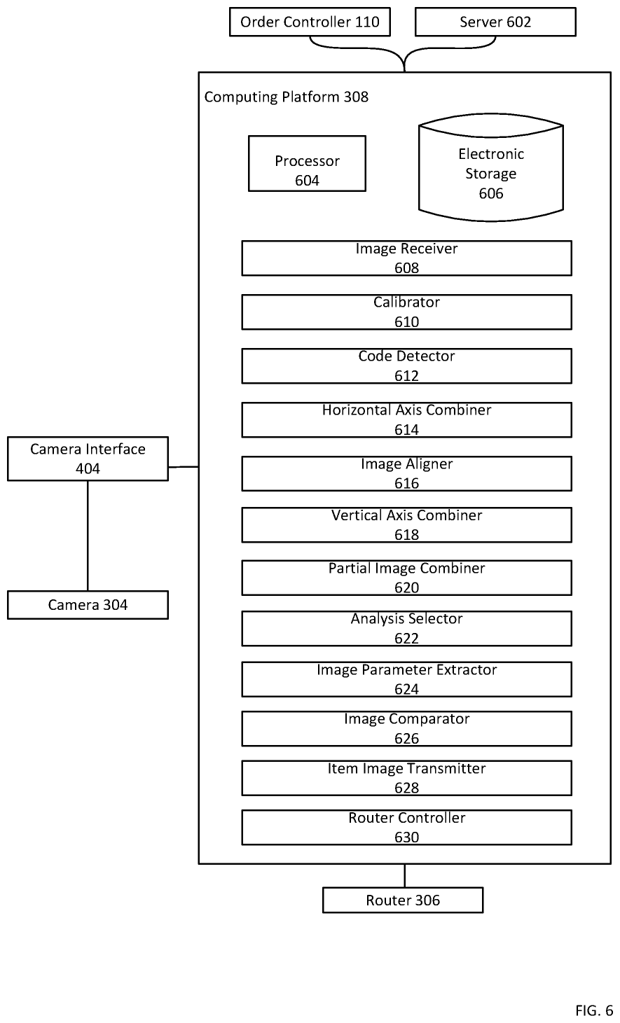

Now referring to FIG. 6, depicted in further detail is an embodiment of the computing platform 308 for analyzing items. The computing platform 308 can communicate with a server 602. The computing platform 308 can include a processor 604 executing machine-readable instructions. The computing platform 308 can include electronic storage 606. The computing platform 308 can include a calibrator 610 calibrating the image stream from the cameras. The computing platform 308 can include an image receiver 608 receiving images from the camera 304 via the camera interface 404. The computing platform 308 can include a code detector 612 detecting code in the image stream. The computing platform 308 can include a horizontal axis combiner 614 combining the image stream along a horizontal axis. The computing platform 308 can include image aligner 616 aligning the horizontally combined images along an axis. The computing platform 308 can include a vertical axis combiner 618 combining the aligned images along a vertical axis. The computing platform 308 can include a partial image combiner 620 combining the partial images into an item image. The computing platform 308 can include an analysis selector 622 identifying a section to analyze within the item image. The computing platform 308 can include an image parameter extractor 624 extracting parameters from the item image or the reference image. The computing platform 308 can include an image comparator 626 generating a correlation score between the extracted parameters of the item image and the reference image. The computing platform 308 can include an item image transmitter 628 transmitting the item image to the server 602 or the order controller 110. The computing platform 308 can include a router controller 630 controlling the router 306.

Still referring to FIG. 6 and in further detail, the computing platform 308 can communicate with a server 602. The server 602 can communicate with the computing platform 308 according to a client/server architecture and/or other architectures. The computing platform 308 can communicate with other computing platforms via the server 602 and/or according to a peer-to-peer architecture and/or other architectures. Users may access the computing platform 308 via the server 602. The computing platform 308 can communicate with an image database via the server 602. Server(s) 602 may include an electronic database, one or more processors, and/or other components. Server(s) 602 may include communication lines, or ports to enable the exchange of information with a network and/or other computing platforms. Illustration of server(s) 602 in FIG. 6 is not intended to be limiting. Server(s) 602 may include a plurality of hardware, software, and/or firmware components operating together to provide the functionality attributed herein to server(s) 602. For example, server(s) 602 may be implemented by a cloud of computing platforms operating together as server(s) 602. In some implementations, server(s) 602, computing platform(s) 308, and/or order controller 110 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 602, computing platform(s) 308, and/or order controller 110 may be operatively linked via some other communication media.

A given computing platform 308 may include a script, program, file, or other software construct executing on hardware, software, or a combination of hardware and software. The computer program scripts, programs, files, or other software constructs may be configured to enable an expert or user associated with the given computing platform 308 to interface with the quality controller 118 and/or external resources, and/or provide other functionality attributed herein to client computing platform(s) 308. In some embodiments, the given computing platform 308 may include one or more of a desktop computer, a laptop computer, a handheld computer, a tablet computing platform, a NetBook, a Smartphone, a gaming console, and/or other computing platforms. The computing platform 308 may include external resources. The external resources may include sources of information outside of the quality controller 118, external entities participating with the quality controller 118, and/or other resources. In some implementations, resources included in the quality controller 118 may provide some or all of the functionality attributed herein to external resources.

Still referring to FIG. 6 and in further detail, the computing platform 308 can include a processor 604 executing machine-readable instructions. The machine-readable instructions can include a script, program, file, or other software construct. The instructions can include computer program scripts, programs, files, or other software constructs executing on hardware, software, or a combination of hardware and software. Processor(s) 604 may be configured to provide information-processing capabilities in computing platform(s) 308. As such, processor(s) 604 may include one or more of a digital processor, an analog processor, a digital circuit designed to process information, an analog circuit designed to process information, a state machine, and/or other mechanisms for electronically processing information. Although processor(s) 604 is shown in FIG. 6 as a single entity, this is for illustrative purposes only. In some implementations, processor(s) 604 may include a plurality of processing units. These processing units may be physically located within the same device, or processor(s) 604 may represent processing functionality of a plurality of devices operating in coordination. Processor(s) 604 may be configured to execute 608, 610, 612, 614, 616, 618, 620, 622, 624, 626, 628, and/or 630, and/or other scripts, programs, files, or other software constructs. Processor(s) 604 may also be configured to execute 608, 610, 612, 614, 616, 618, 620, 622, 624, 626, 628, and/or 630, and/or other scripts, programs, files, or other software constructs by software; hardware; firmware; some combination of software, hardware, and/or firmware; and/or other mechanisms for configuring processing capabilities on processor(s) 604. As used herein, the scripts, programs, files, or other software constructs may refer to any component or set of components that perform the functionality attributed to the scripts, programs, files, or other software constructs. This may include one or more physical processors during execution of processor readable instructions, the processor readable instructions, circuitry, hardware, storage media, or any other components.

Still referring to FIG. 6 and in further detail, the computing platform 308 can include electronic storage 606. The electronic storage 606 can store images, algorithms, or machine-readable instructions. The electronic storage 606 can receive and store reference images from the server 602 or the order controller 110. The reference images can indicate the desired or targeted parameters of an item. Electronic storage 606 may comprise non-transitory storage media that electronically stores information. The electronic storage media of electronic storage 606 may include one or both of system storage that is provided integrally (i.e., substantially non-removable) with computing platform(s) 308 and/or removable storage that is removably connectable to computing platform(s) 308 via, for example, a port (e.g., a USB port, a firewire port, etc.) or a drive (e.g., a disk drive, etc.). Electronic storage 606 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 606 may include one or more virtual storage resources (e.g., cloud storage, a virtual private network, and/or other virtual storage resources). Electronic storage 606 may store software algorithms, information determined by processor(s) 604, information received from computing platform(s) 308, information received from the order controller 110, and/or other information that enables computing platform(s) 308 to function as described herein. The electronic storage 606 can also store images obtained from the cameras 304a-304n.

Referring back to FIG. 6 and in further detail, the computing platform 308 can include the image receiver 608 receiving images from the cameras 304a-304n via the camera interface 404. The image receiver 608 can receive images from the cameras 304a-304n. The image receiver 608 can receive sets of images of the item 402 from sets of camera sources, such as cameras 304a-304n. The image receiver 608 can generate an image stream from the received images. The image receiver 608 can forward the images from the camera interface 404 into the GPU accessible memory. Forwarding the images can result in a technical improvement of reducing data usage typically associated with copying images from CPU memory to GPU memory. Furthermore, the image receiver 608 can receive images from each camera based on a synchronized hardware clock. For instance, in some embodiments, the image receiver 608 can receive and process 1 frame per second from each camera 304.

The image receiver 608 can receive images corresponding to the inspection region 406. The image receiver 608 can receive a first row of images disposed in sequence along an axis perpendicular to the direction of travel of the lateral transport mechanism 302. The first row of images can represent an image frame of the image stream from all the cameras 304a-304n. The image receiver 608 can receive subsequent rows of images representing additional image frames. The images can form a grid where the rows represent a frame for a given time and the columns the contribution from the camera 304. The columns can be parallel to the direction of travel of the lateral transport mechanism 302, and the rows can be perpendicular to the direction of travel of the lateral transport mechanism 302. The image receiver 608 can store the images in the electronic storage 606. The image receiver 608 can share the images with any of the components of the computing platform 308.

Still referring to FIG. 6 and in further detail, the computing platform 308 can include the calibrator 610 calibrating the image stream from the cameras. The calibration of the image stream may be part of a lateral stitch calibration. The calibrator 610 can calibrate the horizontal axis combiner 614. The lateral stitch calibration can align image streams from multiple cameras along an axis into a single image stream. Calibrating the image streams allows the computing platform to combine the overlapping sections of the camera streams targeting the inspection region 406 to combine into an image stream.

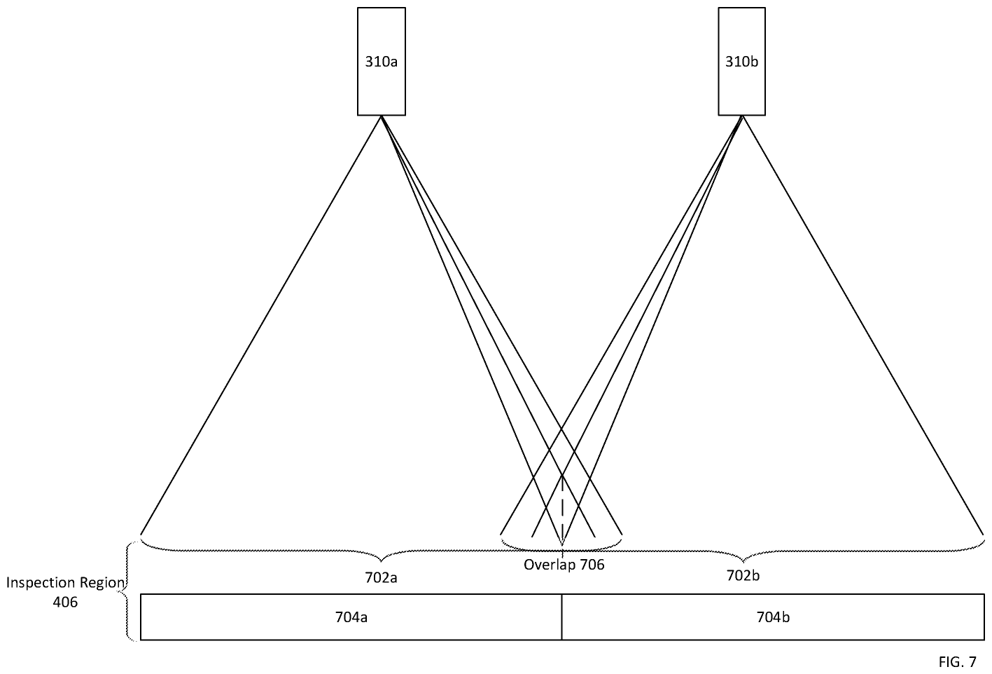

Now referring to FIG. 7, depicted is an embodiment of the camera 304 placement for scanning items in the inspection region 406. The first camera 304a has a first camera view of 702a. The first camera view of 702a is the view of the first camera 304a of the inspection region 406. The second camera 304b has a second camera view of 702b. The second camera view of 702b is the view of the second camera 304b of the inspection region 406. The first camera view 702a and the second camera view 702b can have an overlap 706. The overlap 706 can be an overlapping region, or a section of the inspection region 406 covered by both the first camera 304a and the second camera 304b. By calibrating the first camera view 702a and the second camera view 702b, the overlap 706 disappears from the combined image stream. The calibrated combined image stream can include the first camera portion 704a and the second camera portion 704b. Neither portion will overlap, so the calibrated combined image stream can use multiple cameras to produce a single image stream.

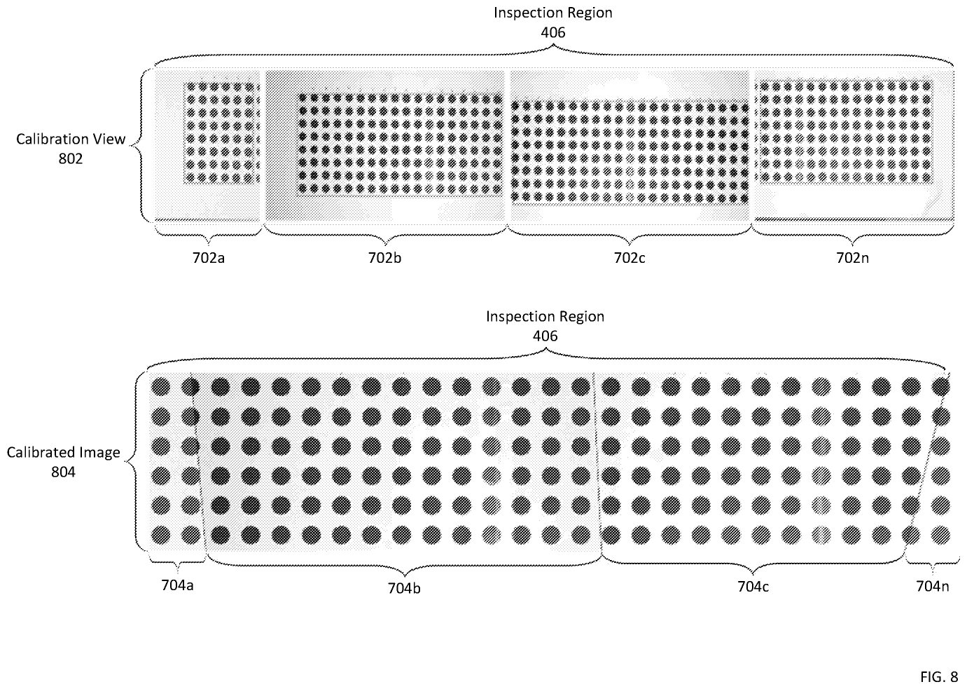

Now referring to FIG. 8, depicted is an embodiment of a camera view of the inspection region 406 for calibrating the cameras. The view before the calibration includes a calibration view 802. The calibration view 802 illustrates a view from each camera 304 of a structured geometric pattern having predetermined parameters. By calibrating the cameras 304 based on the predetermined parameters, the calibrated image 804 depicts a uniform image of the entire inspection region 406 based on an integration of the views from each camera 304.

The calibration view 802 includes the view from each camera 304, such as camera views 702a-702n (generally referred to as camera view 702). Now referring back to FIG. 6, the computing platform 308 can receive the calibration view 802 of a calibration item from the camera sources. The calibration images can include the camera views 702a-702n. The calibration item can be the static calibration grid in the camera views 702a-702n. The calibrator 610 can initiate the calibration process responsive to detecting the static calibration grid. For instance, the lateral transport mechanism 302 may carry a calibration item having predetermined parameters to the inspection region 406. Once the calibration sheet or card is in the inspection region 406, the calibrator 610 can initiate the calibration process. The calibration item can be a calibration sheet or calibration card. The calibration item may have a predetermined calibration parameter. The predetermined calibration parameter can be the shape, dimensions, and positioning of the calibration item.

Referring back to FIG. 8, the static calibration grid can include dots having a predetermined shape, size, and spacing. The calibrator 610 can constantly recalibrate by permanently having the lateral transport mechanism 302 include the static calibration grid. Grid based calibration can facilitate image stitching, which is combination of several overlapping images into a large image. The static calibration grid includes dots. The dots can be in a checkboard pattern, or any structured geometric pattern having predetermined parameters. Based on the structured geometric pattern, the dots can represent a coordinate system of pixels. Each dot can represent a calibration point. Different calibration items can have different dot spacing. For instance, the dots can have an 8-pixel radius, 10-pixel radius, or a 12-pixel radius. Decreasing the radius of the dots can cause distortion while increasing the radius of the dots can decrease the number of available calibration points.

Referring back to FIG. 6, the calibrator 610 can combine the camera views 702a-702n by using the static calibration grid to create a transformation of coordinates for each camera that puts pixels from the camera views 702a-702n into a unified coordinate system.

Referring back to FIG. 8, the calibrated image 804 depicts the image stream of the inspection region 406 after calibrating the camera views 702a-702n. The calibrated image 804 includes a contribution from each of the camera views 702a-702n. The contributions are the camera portions 704a-704n. By combing the camera portion 704a-704n, the calibrated image 804 depicts an integration of the image streams from each camera.

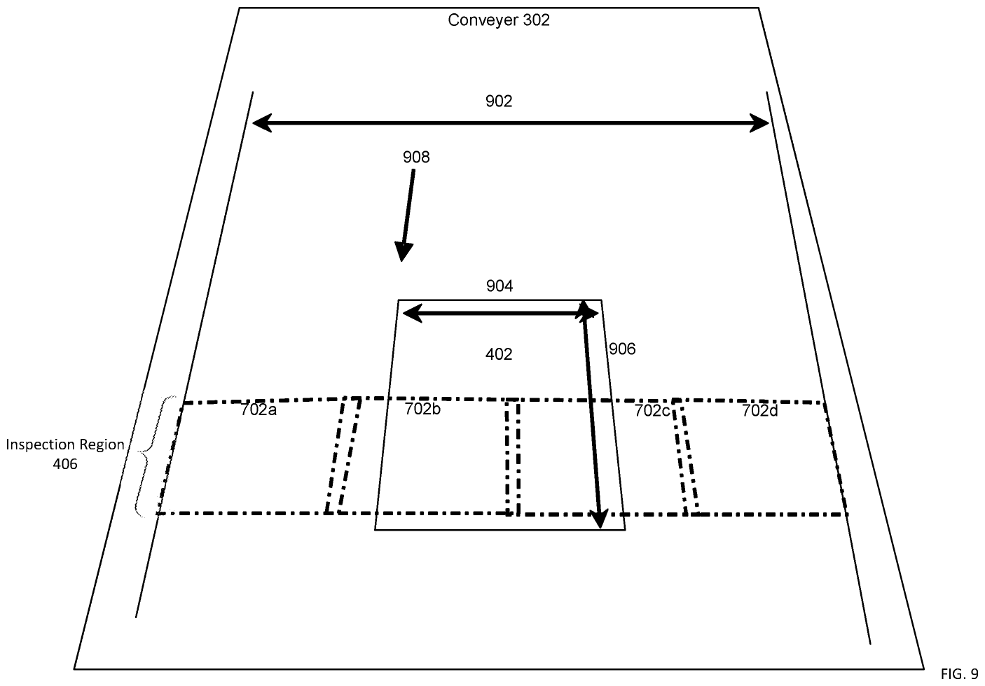

Now referring to FIG. 9, depicted is an embodiment of the item traversing the lateral transport mechanism 302 for analysis in the inspection region 406. The lateral transport mechanism 302 can have a lateral transport mechanism width 902. The lateral transport mechanism width 902 can correspond to the inspection region 406. The item 402 can have an item width 904 and an item length 906. The item 402 traverses along the lateral transport mechanism 302 with a lateral transport mechanism speed 908.

Still referring to FIG. 9 and in further detail, the lateral transport mechanism width 902 can correspond to the width of the inspection region 406. Barriers or visual markers can enclose the lateral transport mechanism width 902. In some embodiments, the lateral transport mechanism width 902 is several inches, several feet, or several yards. The lateral transport mechanism width 902 can scale with the cameras 304. The lateral transport mechanism width 902 can be greater than the item width 904.

Still referring to FIG. 9 and in further detail, the item width 904 can represent the width of the item 402 travelling on the lateral transport mechanism 302. In some embodiments, the item width 904 is several inches or several feet. The item width 904 can be less than the lateral transport mechanism width 902. The item width 904 can fit within the inspection region 406.

Still referring to FIG. 9 and in further detail, the item length 906 can represent the length of the item travelling on the lateral transport mechanism 302. In some embodiments, the item length 906 is several inches or several feet. In some embodiments, the item length 906 fits within the inspection region 406. In some embodiments, the item length 906 exceeds the inspection region 406. The computing platform 308 can stitch the images of the item 402 to generate an image of the entire item even if parts of the item are outside of the inspection region 406 at any given time.

Still referring to FIG. 9 and in further detail, the lateral transport mechanism 302 can predetermine the lateral transport mechanism speed 908. The lateral transport mechanism 302 can adjust the lateral transport mechanism speed 908. The lateral transport mechanism speed 908 can be determined in the camera view 702a-702n as the lateral transport mechanism 302 and the item 402 traverse the inspection region 406.

Referring back to FIG. 6 and in further detail, the calibrator 610 can determine the lateral transport mechanism speed 908. By determining the lateral transport mechanism speed 908, the calibrator 610 can calibrate the image stream for image acquisition and image stitching along the direction of the lateral transport mechanism 302. Based on the lateral transport mechanism speed 908, the computing platform 308 can vertically stitch the images. The calibrator 610 can determine the lateral transport mechanism speed 908 from the images. The calibrator 610 can determine the lateral transport mechanism speed 908 by monitoring pixel maxima of the item 402 travelling along the lateral transport mechanism 302. The calibrator 610 can also determine the lateral transport mechanism speed 908 by monitoring a region of pixels on the lateral transport mechanism 302.

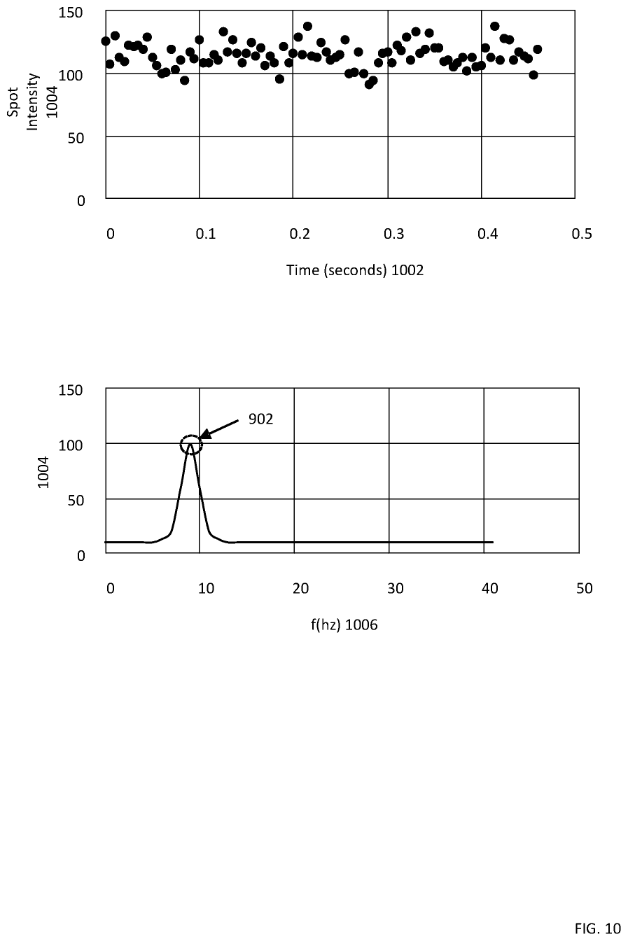

Now referring to FIG. 10, depicted is an embodiment of spot intensity analysis for determining the lateral transport mechanism speed 908. During an acquisition time 1002, the image receiver 608 can receive an image stream of the inspection region 406. During the acquisition time 1002, the calibrator 610 can determine the spot intensity 1004 of each image. Based on the spot intensity 1004 over the acquisition time 1002, the calibrator 610 determines the spot intensity frequency 1006 of each spot intensity 1004. The spot intensity frequency 1006 corresponding to the maxima of the spot intensity 1004 can correspond to the lateral transport mechanism speed 908. The calibrator 610 can determine the lateral transport mechanism speed 908 based on the maxima of the spot intensity 1004.

Still referring to FIG. 10 and in further detail, the acquisition time 1002 can be several seconds. The acquisition time 1002 can be a time corresponding to the typical or average speed of the lateral transport mechanism 302. The acquisition time 1002 can be for the entire operation of the lateral transport mechanism 302. The acquisition time 1002 can correspond to the time domain.

Still referring to FIG. 10 and in further detail, the spot intensity 1004 can represent a particular pixel detected in the image stream. The pixel can correspond to a speed indicator. The speed indicator can be disposed on the lateral transport mechanism 302. In some embodiments, the calibrator 610 can identify the spot intensity 1004 based on placement of the speed indicator. For instance, the speed indicator can be disposed every 5 inches, 10 inches, or 15 inches on the lateral transport mechanism 302. The spot intensity 1004 can correspond to a particular color or section of the item 402. The calibrator 610 can analyze the spot intensity 1004 at predetermined intervals of time.

Still referring to FIG. 10 and in further detail, the spot intensity frequency 1006 can correspond to the frequency of each spot intensity during a particular time. The spot intensity frequency 1006 can correspond to the frequency domain. The spot intensity frequency 1006 at which the spot intensity 1004 is greatest can correspond to the lateral transport mechanism speed 908.

Referring back to FIG. 6 and in further detail, the calibrator 610 can determine the spot intensity frequency 1006 from the spot intensity 1004 over the acquisition time 1002. The calibrator 610 can use a Fast Fourier Transform (FFT) to convert between the frequency domain and the time domain. In some embodiments, the calibrator 610 can employ a temporal FFT to process the small intensity fluctuation of the pixels in time to determine the lateral transport mechanism speed 908. For instance, the frequency domain will indicate the most common frequency of the spot intensity 1004. The most common frequency can correspond to the lateral transport mechanism speed 908.

Referring back to FIG. 6, the computing platform 308 can include a code detector 612 detecting a code in the image stream. The code may have a unique item identifier. The unique item identifier can correspond to an item that the computing platform 308 can analyze. The code detector 612 can detect the code in any of the images. The code detector 612 can detect the code based on measurements from the location sensor, temperature sensor, or the position sensor. The code detector 612 can detect codes such as QR codes or bar codes. The code detector 612 can store the code in the electronic storage 606. In some embodiments, the code detector 612 identifies codes based on accessing predetermined codes stored in the electronic storage 606. The predetermined codes may have an expected location and quantity. For instance, the predetermined codes can indicate where the codes are typically located, such as near the left edge of the lateral transport mechanism 302. Similarly, the predetermined codes can indicate how many codes the code detector 612 may identify on an item, such as three codes. For instance, the predetermined codes can indicate that a bag has a first code and the item in the bag has a second code. Based on the predetermined codes, the code detector 612 can determine a type and location of the codes. The code detector 612 can convert the detected code to a data entry, such as a numerical representation of the code. The code detector 612 can generate a code flag responsive to detecting the code. The code detector 612 can store the code flag in the electronic storage 606.

Referring back to FIG. 6 and in further detail, the horizontal axis combiner 614 can combine the images along a horizontal axis into a horizontal portion. The horizontal axis combiner 614 can combine the images responsive to detecting the code flag from the code detector 612. The horizontal axis combiner 614 can combine the image stream along a horizontal axis. The horizontal axis can be perpendicular to the direction of travel of the item 402 along the lateral transport mechanism 302. The horizontal axis combiner 614 can combine the images based on the calibration performed by the calibrator 610. The horizontal axis combiner 614 can laterally stitch the images. The horizontal axis combiner 614 can convert each camera view 702 to a view of the inspection region 406. The view will include a contribution from each camera 304, and each contribution can be the camera portion 704.

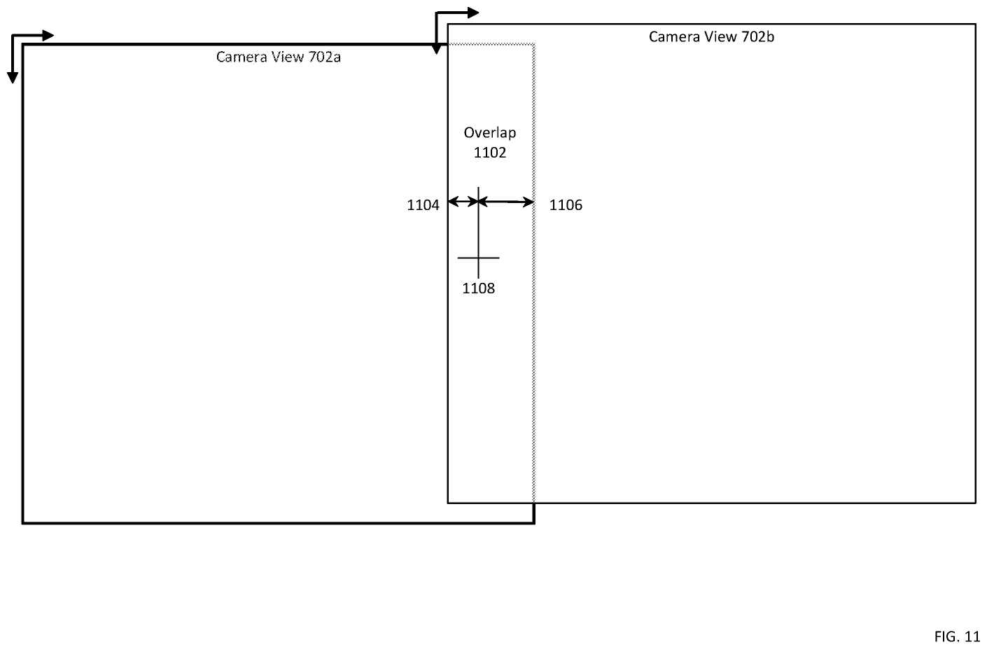

Now referring to FIG. 11, depicted is an embodiment of the horizontal axis combiner 614 for combining images as a fade. The images can correspond to the camera view 702a and camera view 702b. The two views may have the overlap 1102. The horizontal axis combiner 614 can combine the images by merging a first camera mesh 1104 and second camera mesh 1106 based on the target 1108. The horizontal axis combiner 614 can combine the pixels in the overlap region with a weighting factor. The horizontal axis combiner 614 can calculate the weighting factor based on the relative lateral distances between the mesh 1104, the mesh 1106, and the target 1108. The horizontal axis combiner 614 can perform the combining by calculating:

I_{S}(x,y)=I_{L}(x,y)*ΔL/ΔL+ΔR+I_{R}(x,y)*ΔR/ΔL+ΔR

I_{L} can be the edge of the camera view 702a and ΔL can be the overlap distance of the camera view 702a with camera view 702b. I_{R} can be the edge of the camera view 702B and OR can be the overlap distance of the camera view 702b with camera view 702a. The horizontal axis combiner 614 can adjust the calculations based on the number of cameras used for each application. The calculations can be identical for each pair of cameras having an overlapping camera field of view, such as overlap 706.

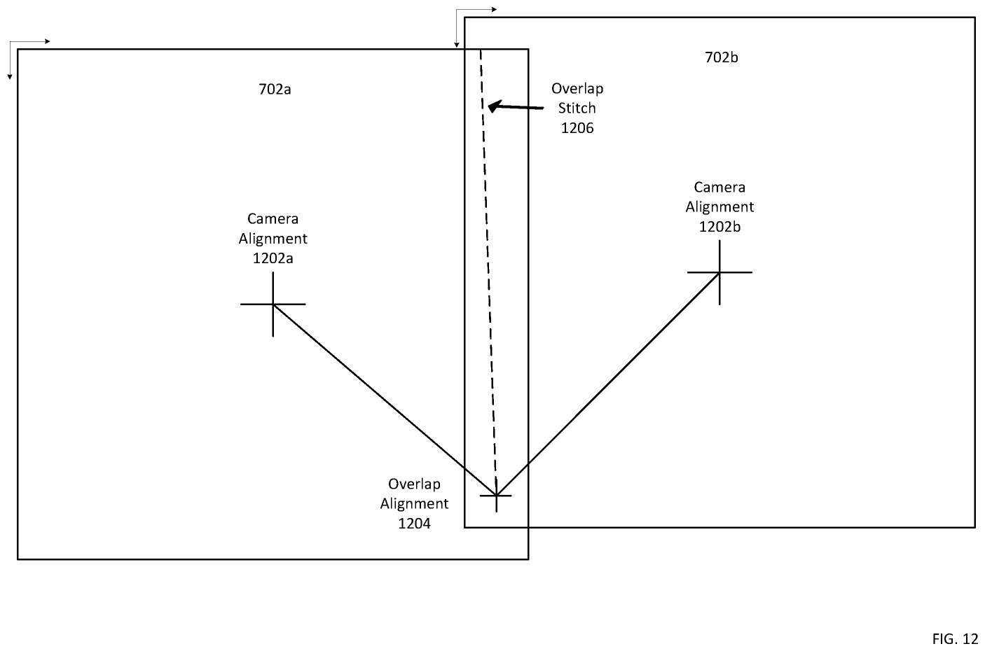

Now referring to FIG. 12, depicted is an embodiment of the horizontal axis combiner 614 for combining images as a discrete seam. The horizontal axis combiner 614 can combine coplanar image data along the discrete seam. The images can correspond to the camera view 702a and camera view 702b. The horizontal axis combiner 614 can identify the camera alignment 1202a in the camera view 702a, and the camera alignment 1202b in the camera view 702b, and the overlap alignment 1204. The horizontal axis combiner 614 can combine the images based on the alignments. The horizontal axis combiner 614 can combine the images along the overlap stitch 1206. For instance, the convolution or mixing of a two dimensional image, such as an image obtained with a tele centric lens, with three dimensional information, such as an image associated with a predetermined numerical aperture, can determine the discrete seam. The horizontal axis combiner 614 can calculate a discrete stitch boundary such that the distance from the camera alignment 1202a and camera alignment 1202b to the overlap alignment 1204 is equal. Based on two-dimension image and the three-dimension image, the convolution can increase. The convolution can increase outwards from the zero at the field of view center, such as overlap alignment 1204. Based on calculating the discrete seam via convolution, the three dimensional effects along the overlap stitch 1206 can be equivalent for both cameras, such as from camera view 702a and camera view 702b.

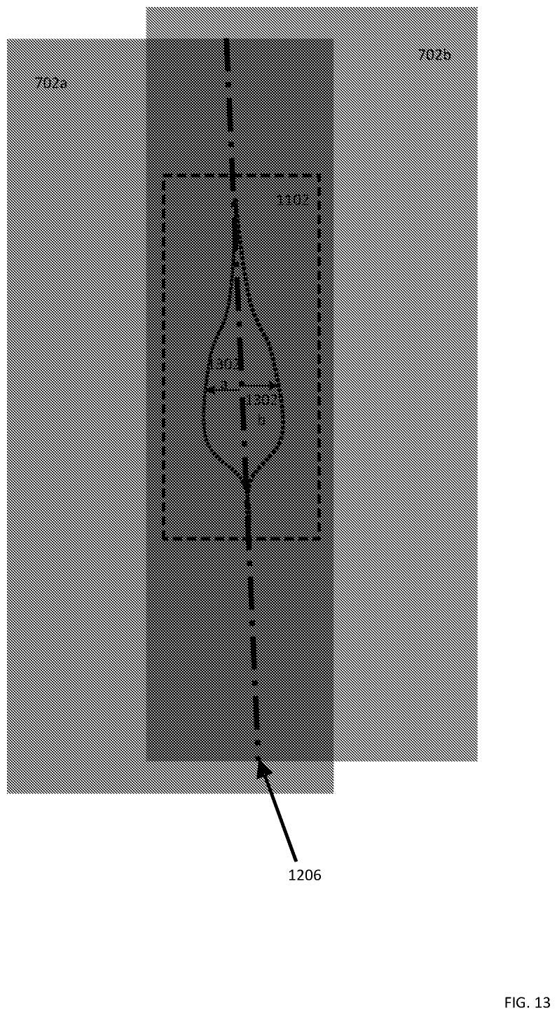

Now referring to FIG. 13, depicted is an embodiment of the horizontal axis combiner 614 for combining images of nonplanar items. The images can correspond to the camera view 702a and camera view 702b. The two views may have the overlap 1102. Since the calibrator 610 has a-priori information of approximately where the overlap stitch 1206 is located, the horizontal axis combiner 614 can start by assuming that the items are planar. However, in some embodiments, jagged items in the overlap 1102 region convolve the data with nonplanar objects, which can cause stitch errors. For instance, if the item 402 has 3D structures that convolve the data, stitch errors can occur. In some embodiments, the stitch errors can occur in the overlap 1102 or along the overlap stitch 1206. Nonplanar items can deviate the overlap stitch 1206 from the approximate location by an amount based on the deformities of the item 402. The horizontal axis combiner 614 can create hybrid stitches 1302a-1302n (generally referred to as hybrid stitch 1302) within the overlap 1102. The horizontal axis combiner 614 can base the hybrid stitch 1302 on the overlap stitch 1206, but then the horizontal axis combiner 614 can pull the hybrid stitch 1302 outwards as the horizontal axis combiner 614 identifies 3D features within the images. For instance, the horizontal axis combiner 614 can perform a hybrid stitch 1302 by adjusting, at every point along the overlap stitch 1206, the overlap stitch 1206 based on an ideal planar stitch. Referring now to FIG. 7, the adjustment can occur where the overlap stitch 1206 falls along 3D structures. The 3D structures can be imaging ray traces of the camera pair that shift outwards from the camera FOV center, such as the camera alignment 1202a or camera alignment 1202b. The imaging ray traces can intersect at a predetermined point on a predetermined 3D structure above an ideal plane. The extent of the outward shifting at each pixel along the ideal seam can be determined based on a variety of techniques. The outward shifting in each camera portion, such as camera portion 702a or the camera portion 702b, can generate a preliminary combined image having source pixel information exceeding an excess threshold. The horizontal axis combiner 614 can map the excess source pixel information into the combined image based on a weighted fade.

In some embodiments, the horizontal axis combiner 614 can base the outwards pulling of the hybrid stitch 1302 based on a smooth function. In some embodiments, the horizontal axis combiner 614 can identify the 3D features by calculating the 3D topography in the overlap region based on stereoscopic algorithms. In other embodiments, the horizontal axis combiner 614 can identify the 3D features based on iterations of seam adjustments based on a measure of pixel-to-pixel smoothness. The horizontal axis combiner 614 can combine the images by merging the first camera view 702a with the second camera view 702b based on the hybrid stitches.

Referring back to FIG. 6 and in further detail, the computing platform 308 can include the image aligner 616 aligning the horizontal portions along an axis. The image aligner 616 can rotate images to orient them for further combination. The image aligner 616 can rotate the combined images created by the horizontal axis combiner 614. The image aligner 616 can dispose the combined images into a coordinate system defined by the calibration targets used by the calibrator 610. A physical calibration standard, such as the array of dots depicted in FIG. 8, can form the coordinate system. The image aligner 616 can transform or rotate the combined images along the coordinate system. The orientation of the physical calibration standard can approximately align with the cameras 304, but the cameras 304 can have an imperfect alignment with the lateral transport mechanism 302, so the combined images created by the horizontal axis combiner 614 may have different angular orientations. To standardize the angular orientation of each combined image, the image aligner 616 can rotate each combined image to the negative of the angle calculated based on the normal of the lateral transport mechanism 302 direction of travel and the axis along the array of cameras 304. For instance, the image aligner 616 can rotate the images parallel to the row of the cameras 304, or perpendicular to the direction of travel of the item 402 along the lateral transport mechanism 302. In some embodiments, the image aligner 616 can align, responsive to detecting the code, along a second axis perpendicular to a first axis, combined images into aligned images. The first axis can be in the direction of travel on the lateral transport mechanism 302, and the second axis can be perpendicular to the direction of travel. The image aligner 616 can identify, responsive to detecting the code, a second row of images of the first set of images. The second row of images can represent the additional row of the item image. For instance, the first row can represent the item in the inspection region 406 at a first time, and the second row can represent the item in the inspection region 406 at a second time after the item traveled along the lateral transport mechanism 302. The image aligner 616 can align the second row with the first row. For instance, the image aligner 616 can align the second row parallel to the first row. Each of the aligned images can be combinable to form partial images. Each rotated image can represent a horizontal portion of the item image. The image aligner 616 may generate or identify, responsive to detecting the code, a first row of images of the first set of images. The first row of images can be the rotated images. The first set of images can combine into the item image. The image aligner 616 can keep combining images to form additional rows of aligned images. For instance, the image aligner 616 can combine, responsive to detecting the code, along the second axis perpendicular to the first axis, the first set of images into the first set of combined images. By aligning the rows of horizontal portions, the image aligner 616 can prepare the horizontal portions for combining along an axis perpendicular to the rows. For instance, once the image aligner 616 aligns the combined images, the vertical axis combiner 618 can stitch each aligned image together into an item image.

Still referring to FIG. 6 and in further detail, the computing platform 308 can include a vertical axis combiner 618 combining the aligned horizontal portions along a vertical axis. The vertical axis combiner 618 can combine the aligned horizontal portions along the second axis perpendicular to the first axis. The vertical axis combiner 618 may combine the aligned images responsive to the code detector 612 detecting the code. The vertical axis combiner 618 can combine rows of aligned images into sets of vertically combined images. The vertical axis combiner 618 can combine, along the vertical axis, rows of images into a column of aligned images. The vertical axis combiner 618 can combine, along the second axis perpendicular to the first axis, the second set of images into a second set of combined images. The vertical axis combiner 618 can combine, responsive to detecting the code, along the second axis perpendicular to the first axis, the first set of images into the first set of combined images. The vertical axis combiner 618 may also combine, along the second axis, the second row of images into a second combined row image of the first set of combined images. The first row of rotated images may be disposed along the second axis. The second row of rotated images may be disposed along the second axis. Combining, along the first axis, the first set of rotated images into the second partial item image may include combining, along the second axis, a third row of rotated images and a fourth row of rotated images into the second partial item image. The vertical axis combiner 618 can also combine the columns of images into sets of partial item images. Each partial item image can correspond to a portion of the item.

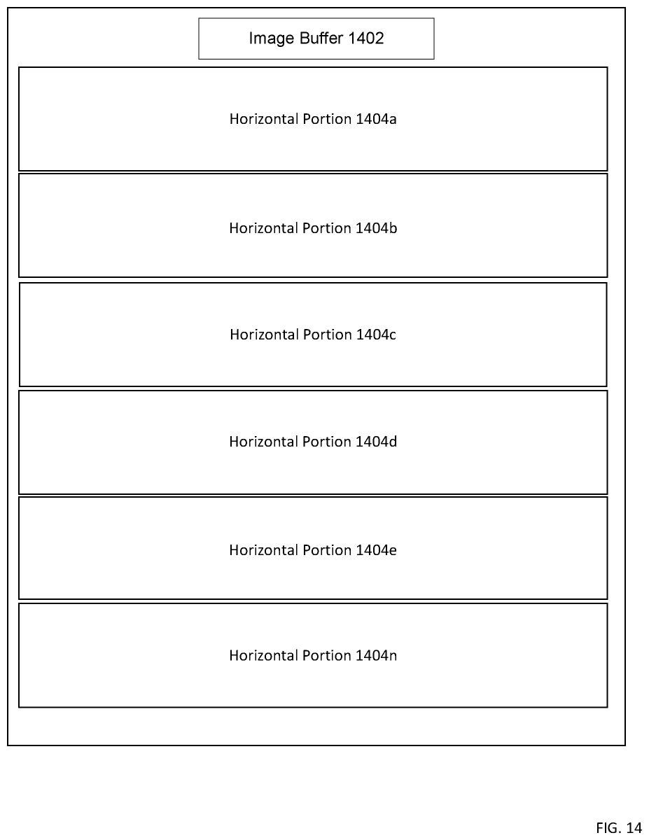

Now referring to FIG. 14, depicted is an embodiment of an image buffer for combining a stack of horizontal images into a partial item image. The stack of horizontal images can be stored in the image buffer 1402. The image buffer 1402 can include horizontal portions 1404a-1404n (generally referred to as horizontal portion 1404). The horizontal axis combiner 614 can transmit each horizontal portion 1404 to the image buffer 1402. The image buffer 1402 can maintain a quantity of horizontal portions greater than equal to the amount required to reconstruct an item image of the item 402. The vertical axis combiner 618 can reconstruct horizontal portions from the image buffer 1402 into item images of the item occurring after the code detector 612 detects the first horizontal portion of that item. The first horizontal portion can include the code detected by the code detector 612. Each horizontal portion 1404 can be a row of the aligned or rotated images. Since portions of separate items may be visible in the full camera field of view, such as by spanning the lateral transport mechanism 302, the separate portions of partially side-by-side items will come into the inspection region 406 at different times. Since the separate portions arrive at different times, the image buffer 1402 allows for use of variable slice sets in each horizontal portion of the item 402. Each horizontal portion 1404 can correspond to a portion of the item 402 in the inspection region 406 at a given time. For instance, if the cameras 304 capture an image every second, then each horizontal portion 1404 can represent the camera's field of view during a particular second. By combining each horizontal portion 1404, the computing platform 308 can generate an image of an item 402 that is larger than the inspection region 406. The vertical axis combiner 618 can combine each horizontal portion 1404 to generate a partial image.

Referring back to FIG. 6 and in further detail, the vertical axis combiner 618 can combine the horizontal portions 1404 into an item image of the item 402. The vertical axis combiner 618 can combine the horizontal portions 1404 after the image aligner 616 rotates them into alignment. In some embodiments, the vertical axis combiner 618 can crop or skip horizontal portions 1404 in the image buffer 1402 based on code or the lateral transport mechanism speed 908. The vertical axis combiner 618 can combine, along the axis perpendicular to the lateral transport mechanism 302 direction of travel, the horizontal portions into partial images. The vertical axis combiner 618 can combine the horizontal portions responsive to the code detector 612 detecting the code. The vertical axis combiner 618 can transmit the horizontal portions that are side by side to the horizontal axis combiner 614 for combining the side-by-side horizontal portions into a greater horizontal portion. The side-by-side horizontal portions can be columns of horizontal portions. The vertical axis combiner 618 can combine the horizontal portions responsive to identifying a row of images or a particular horizontal portion. For instance, responsive to identifying a horizontal portion having a code, the vertical axis combiner 618 can combine the horizontal portions from a time prior to the horizontal portion having the code.

Still referring to FIG. 6, the computing platform 308 can include the partial image combiner 620 combining the partial images into the item image. The vertical axis combiner 618 can generate the partial images. The partial images make up the portions of the item image. The partial image combiner 620 can rotate the partial images to orient them perpendicular to the lateral transport mechanism 302 direction. The partial image combiner 620 can rotate each partial image into a rotated horizontal portion. The partial image combiner 620 can combine a first partial item image and a second partial item image into the item image. In some embodiments, the partial image combiner 620 can combine partial item images from different times or different lateral transport mechanism 302. For instance, the partial image combiner 620 can combine a first image of a shirt from a first lateral transport mechanism and a second image of pants from a second lateral transport mechanism. The computing platform 308 can analyze the combined shirt and pants image as a suit.

Still referring to FIG. 6, the computing platform 308 can include the analysis selector 622 identifying a section to analyze within the item image. A user can select the section within the image. The analysis selector 622 can automatically select the item within the image. The analysis selector 622 can select an analysis region based on computer-vision segmentation algorithms, or machine learning object detection convolution neural networks (R-CNN). The analysis selector 622 can select the item within the image based on measurements from the location sensor, temperature sensor, or the position sensor. For instance, the analysis selector 622 can select a logo to analyze within the item. The logo may have a complex design, and the quality controller 118 may want to verify the logo's manufacturing. The analysis selector 622 can select the section for analysis and transmit the section to the image parameter extractor 624.

Still referring to FIG. 6, the computing platform 308 can include an image parameter extractor 624 extracting item image parameters from the item image or the reference image. The image parameter extractor 624 can extract an item image parameter from the item image. The image parameter extractor 624 can the item image parameter based on measurements from the location sensor, temperature sensor, or the position sensor. The item image parameter can be a dimension, a color scheme, or a fabric composition.

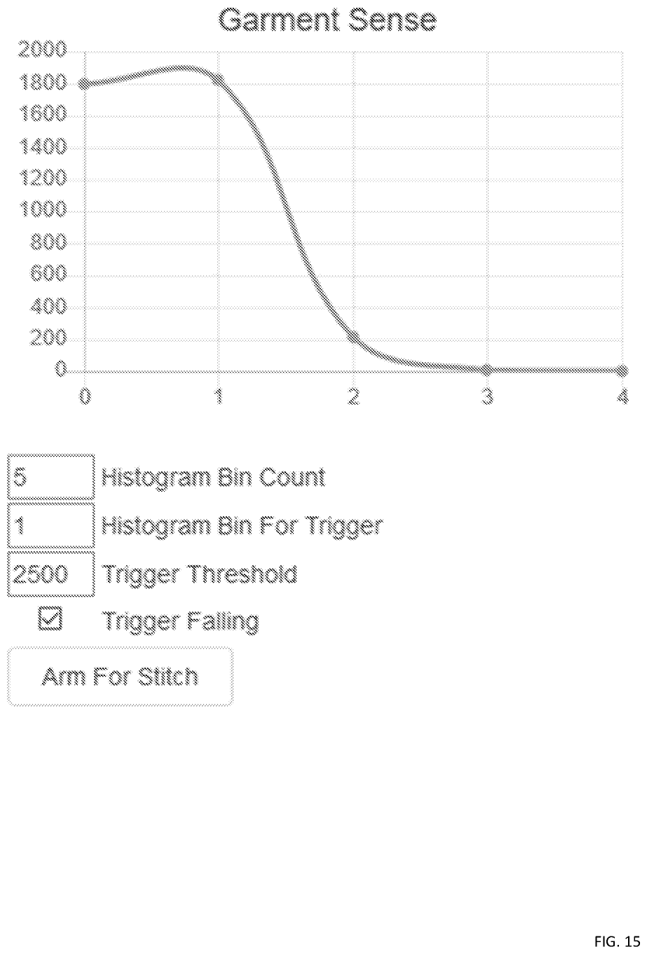

Now referring to FIG. 15, depicted is an embodiment of an image histogram for analyzing the parameters of the image. The image histogram can depict the color distribution of the image by the number of pixels for each color value. For instance, the x-axis can represent each color, and the y-axis can represent the frequency of each color. By extracting the color composition and other parameters of the image, the image parameter extractor 624 can allow the computing platform 308 to compare the item images to reference images. The image parameter extractor 624 can generate the image histogram from the image stream coming from the cameras 304. The image parameter extractor 624 can store the image histogram to the electronic storage 606. The image parameter extractor 624 can generate and store a reference image histogram when the inspection region 406 is empty. The image parameter extractor 624 can continuously generate or store additional image histograms. The image parameter extractor 624 can compare the additional image histograms to the reference image histograms. Based on the comparisons, the image parameter extractor 624, can detect when a portion of the item 402 detected by the code detector 612 is in the inspection region 406. In some embodiments, the image parameter extractor 624 includes a machine-learning model that trains on predetermined or reference image histograms. Based on the training, the image parameter extractor 624 can automatically detect when the item 402 is in the inspection region 406. Similarly, the image parameter extractor 624 can detect when a particular portion of the item 402 is in the inspection region 406.

Now referring back to FIG. 6, the image parameter extractor 624 can extract reference image parameters from a reference image. The image parameter extractor 624 can include predetermined machine learning models for extracting and classifying the parameters from the images. Operators of the quality controller 118 can add data to further train the neural network of the image parameter extractor 624. The reference image can be an ideal image stored in an image database. The image database can be the electronic storage 606. The image parameter extractor 624 can extract item image parameters from the reference image. The reference image can be the image of the item. The user or the quality controller 118 can provide the reference image. Each reference image can correspond to a code. The image parameter extractor 624 can look up the reference based on the code detected by the code detector 612. The item image parameter can be a dimension, a color scheme, or a fabric composition. The computing platform 308 can store the reference image parameters in the electronic storage 606. In some embodiments, the image parameter extractor 624 predetermines the reference image parameters prior to the computing platform 308 analyzing the items. Based on the reference image parameters, the image parameter extractor 624 can determine possible types, classifications, or locations of the defects. The locations of the defects can be on the coordinate plane defined by the calibrator 610.

Still referring to FIG. 6, the computing platform 308 can include an image comparator 626 generating a correlation score between the extracted parameters of the item image and the reference image. The image comparator 626 can compare the parameters of the reference image to the parameters of the item image. For instance, the image comparator 626 can compare the color composition of the reference image to the item image. The image comparator 626 can generate a correlation score between the item image and the reference image by comparing the item image parameters to the reference image parameters. For instance, the image comparator 626 can apply an image correlation algorithm to determine a relationship between the reference image and the item image. Based on the image correlation algorithm, the image comparator 626 can determine a relationship or correlation between each pixel of the reference image and the item image. The image comparator 626 can extract, responsive to the correlation score satisfying the predetermined correlation threshold, a sectional image parameter corresponding to an item image section of the item image. In some embodiments, the image comparator 626 can compare the sectional image parameter to the ideal image parameter to generate a sectional correlation score of the item image section. The sectional image parameter can represent the image parameters of the item image section selected by the analysis selector 622. For instance, the image comparator 626 can generate a correlation score indicating a match between the reference image and the item image responsive to the two images having similar colors. The image comparator 626 can indicate the similarity of the colors with a color similarity score. For instance a reference image and an item image having nearly identical colors can have a high color similarity score, while a reference image and an item image having different colors have a low color similarity score. The image comparator 626 can also compare the dimensions of the reference image and the item image. For instance, the reference image could have a logo taking up fewer pixels than a similar logo in the item image. Therefore, even though the colors of the two logos may be similar, the image comparator 626 would flag the size discrepancy for review.

Still referring to FIG. 6, the computing platform 308 can include an item image transmitter 628 transmitting the item image to the server 602 or the order controller 110. The item image transmitter 628 can transmit, responsive to the correlation score satisfying a predetermined correlation threshold, the item image to the server 602 or the electronic storage 606. The predetermined correlation threshold can indicate that the image comparator 626 determined that the item image was similar to the reference image. The item image transmitter 628 can also transmit the item image section having the sectional correlation score satisfying a predetermined sectional correlation score. The predetermined correlation threshold can indicate that the image comparator 626 determined that the section of the item image was similar to the reference image. The item image transmitter 628 can also transmit the item image responsive to the image comparator 626 comparing the item image to the reference image.

Still referring to FIG. 6, the computing platform 308 can include a router controller 630 controlling the router 306. In some embodiments, the router controller 630 can transmit, to the router 306, a scrap signal requesting that the router 306 route the item 402 to the order controller 110. The quality controller 118 can scrap or trash items associated with a scrap signal. In some embodiments, the router controller 630 can transmit, to the router 306, a recovery signal requesting that the router 306 route the item to the order controller 110. The quality controller 118 can remanufacture or fix Items associated with a recovery signal. In other embodiments, the router controller 630 can transmit, to the router 306, an approval signal requesting that router 306 route the item to the shipper 120. The quality controller 118 can approve items associated with an approval signal for shipping. The router controller 630 can transmit the scrap signal, recovery signal, and the approval signal based on the correlation scores of the item 402 to an associated reference image. For instance, router controller 630 can transmit, responsive to the correlation score satisfying the predetermined correlation threshold, the approval signal. The router controller 630 can also transmit the approval signal for an item having the sectional correlation score satisfy a predetermined sectional correlation score. The correlation score satisfying the predetermined correlation threshold can indicate that the item 402 does not have any defects. For instance, if the item image resembles the reference image, then the item is eligible for shipment to the customer. Alternatively, if the item does not satisfy the predetermined scores, then the item has defects. A scrap signal may be associated with an item having a correlation score satisfying a predetermined scrap score. The scrap score can indicate that the item has too many defects to for the manufacturer 112 or the quality controller 118 to fix. If the item 402 has defects that the manufacturer 112 or the quality controller 118 can fix, then the item 402 can have a correlation score between the scrap score and correlation threshold. The router controller 630 can also transmit the verification signal indicating that the router 306 sends the item back to the order controller 110 for analysis, such as to determine how certain manufacturing methods were associated with certain features of the item.

It should be appreciated that although 608, 610, 612, 614, 616, 618, 620, 622, 624, 626, 628, and/or 630 are illustrated in FIG. 6 as being implemented within a single processing unit, in implementations in which processor(s) 604 includes multiple processing units, one or more of 608, 610, 612, 614, 616, 618, 620, 622, 624, 626, 628, and/or 630 may be implemented remotely from the others. The description of the functionality provided by 608, 610, 612, 614, 616, 618, 620, 622, 624, 626, 628, and/or 630 described below is for illustrative purposes, and is not intended to be limiting, as any of 608, 610, 612, 614, 616, 618, 620, 622, 624, 626, 628, and/or 630 may provide more or less functionality than is described. For example, one or more of 608, 610, 612, 614, 616, 618, 620, 622, 624, 626, 628, and/or 630 may be eliminated, and some or all of their functionality may be provided by other ones of 608, 610, 612, 614, 616, 618, 620, 622, 624, 626, 628, and/or 630. As another example, processor(s) 604 may be configured to execute one or more additional scripts, programs, files, or other software constructs that may perform some or all of the functionality attributed below to one of 608, 610, 612, 614, 616, 618, 620, 622, 624, 626, 628, and/or 630.

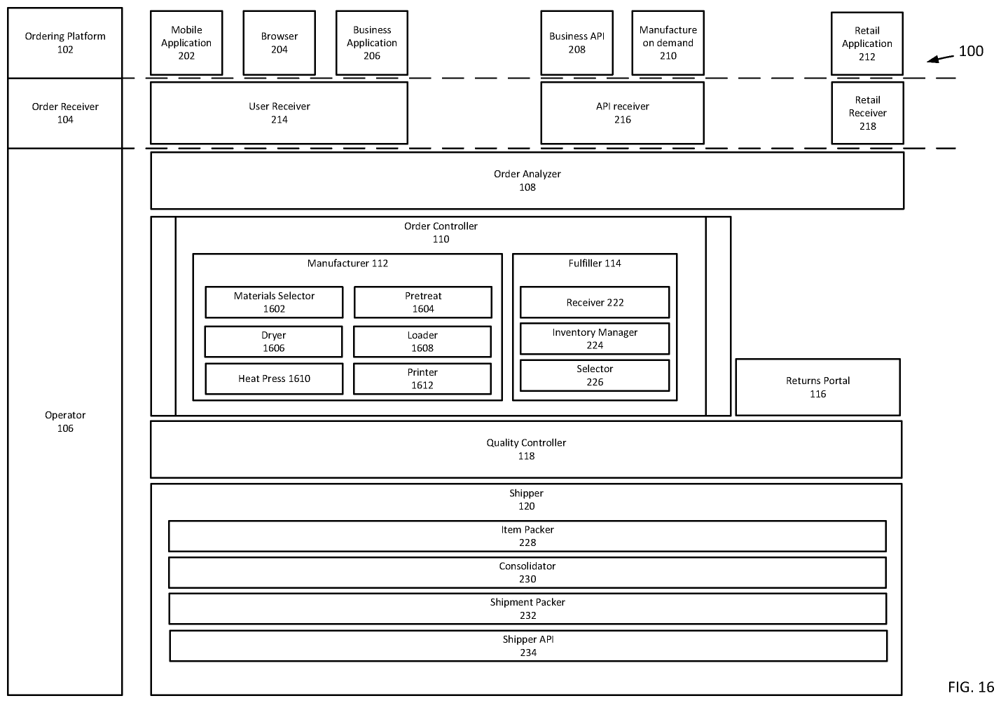

Now referring to FIG. 16, depicted is an embodiment of the system 100 configured for scanning garments at the point of manufacturing. As shown in FIG. 16, the manufacturer 112 can include a materials selector 1602 selecting materials for manufacturing the garments. The manufacturer 112 can include a pretreat 1604 preparing the materials for manufacturing. The manufacturer 112 can include a dryer 1606 drying the materials. The manufacturer 112 can include a loader 1608 loading the materials into the heat press 1610 or the printer 1612. The manufacturer 112 can include a heat press 1610 heating and pressing the materials. The manufacturer 112 can include a printer 1612 printing on the materials.

Still referring to FIG. 16 and in further detail, the materials selector 1602 can select materials for manufacturing the garments. For instance, the materials can be for manufacturing shirts or pants. The materials can be animal sourced such as wool or silk; plant sourced such as cotton, flax, jute, bamboo; mineral sourced such as asbestos or glass fiber; and synthetic sourced such as nylon, polyester, acrylic, rayon. The materials selector 1602 can select the materials based on the order specifications received by the order analyzer 108. For instance, the materials selector 1602 can select materials based on specified textile strengths and degrees of durability.

Still referring to FIG. 16 and in further detail, the pretreat 1604 can prepare the selected materials for manufacturing. The pretreat 1604 can mechanically and chemically pretreat textile materials made from natural and synthetic fibers, such as any of the materials selected by the materials selector 1602. The pretreat 1604 can apply a treatment to the materials before dyeing and printing of the materials. The pretreat 1604 can size, scour, and bleach the selected materials. The pretreat 1604 can wash the materials. Similarly, the pretreat 1604 can remove dust or dirt from the materials. The pretreat 1604 can convert materials from a hydrophobic to a hydrophilic state. The pretreat 1604 can send the material through multiple cycles of pretreating to reduce uneven sizing, scouring, and bleaching. The pretreat 1604 can determine the number of cycles based on the order specifications, such as a desired color or whiteness.

Still referring to FIG. 16 and in further detail, the dryer 1606 can dry the materials. The dryer 1606 can dry the materials after the materials are treated by the pretreat 1604. The dryer 1606 can de-water the materials. The dryer 1606 can remove liquids from the materials. The dryer 1606 can dry any of the materials selected by the materials selector 1602. The dryer 1606 can dry the materials with a gas burner or steam. The dryer 1606 can include a fan blowing air or steam on the materials. The dryer 1606 can also vibrate the materials to remove liquid. The dryer 1606 can include chambers for the materials. The chambers can have a predetermined temperature to for each kind of material. The dryer 1606 can include overfeeding the materials by a belt carrying the materials in and out of the chambers. The overfeed percentage, chamber temperature, and belt speed can be set by the dryer 1606 based on predetermined reference values associated with each material.

Still referring to FIG. 16 and in further detail, the loader 1608 can load the materials into the heat press 1610 or the printer 1612. The loader 1608 can improve the ability of the manufacturer 112 to properly load materials into the heat press 1610 or the printer 1612 by providing real time flatness feedback and alignment verification of the materials. The manufacturer 112, such as the heat press 1610 or the printer 612, can have difficulty flattening the material and determining if the alignment of the material. However, the loader 1608 can assist with the loading of materials having verified alignment for the production of high quality printed products with a low scrap rate.

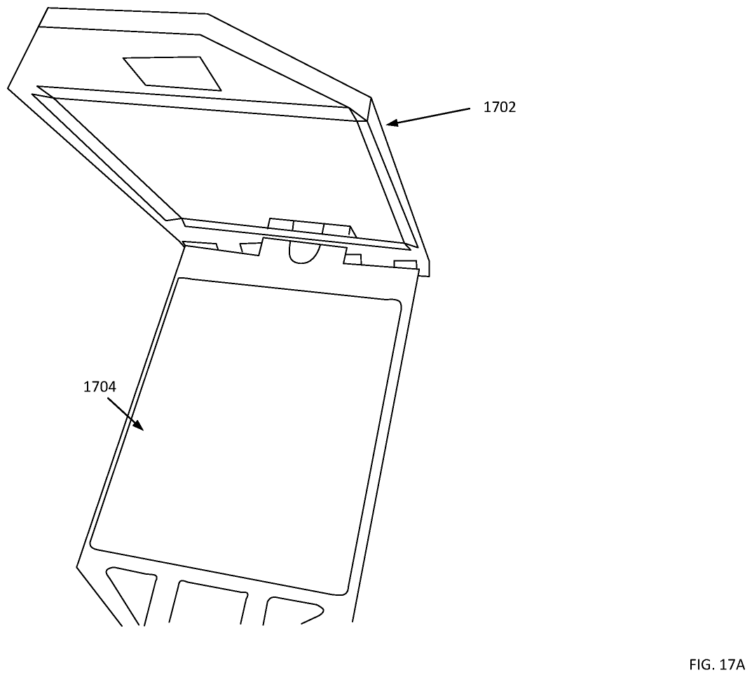

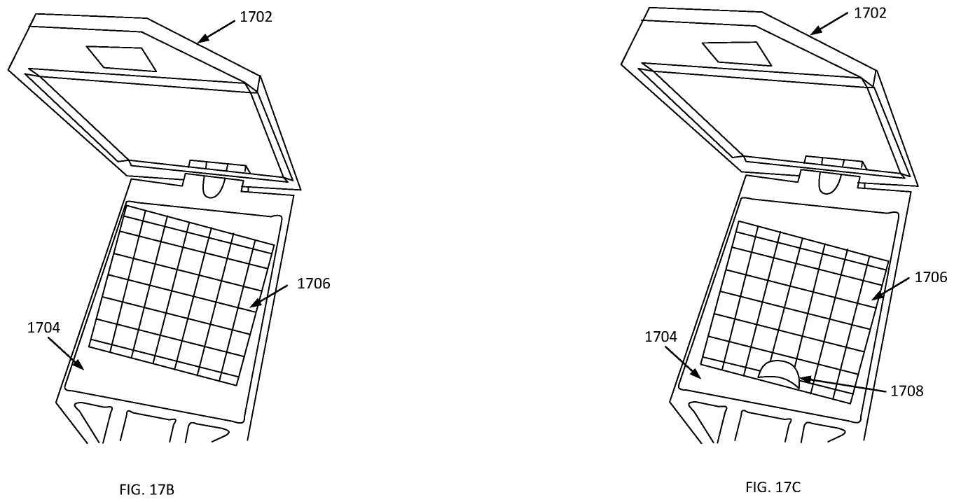

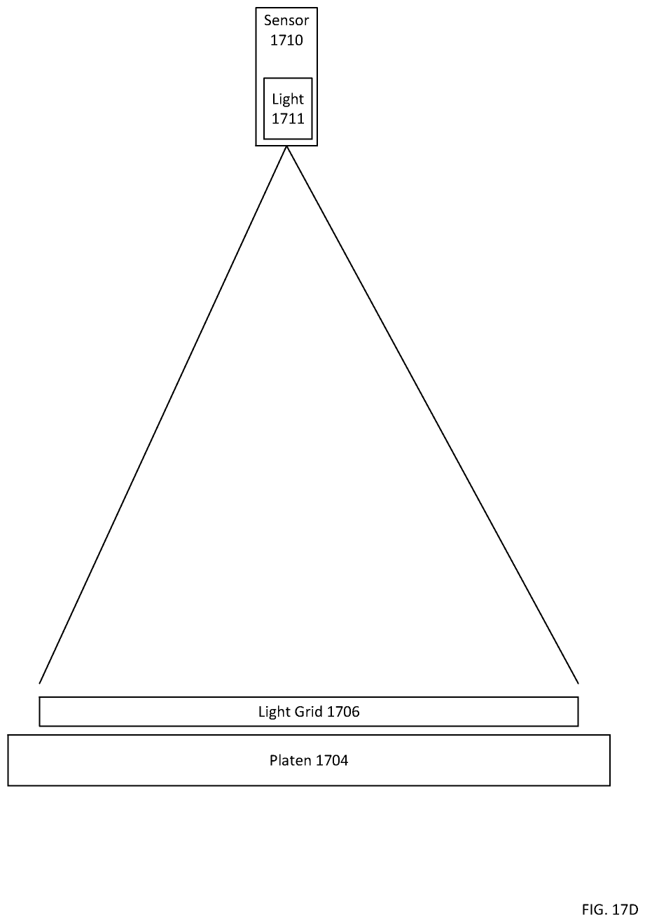

Now referring to FIG. 17A, depicted is an embodiment of the loader 1608 for loading garments at the point of manufacturing. The loader 1608 can include a lid 1702 and a platen 1704. The lid 1702 can open or close the platen 1704. The lid 1702 can be a frame for surrounding and securing the objects disposed on the platen 1704. The platen 1704 can be a flat board made out of plastic or metal. The platen 1704 can include a heat-safe padding cover. The platen 1704 can receive objects such as the item 402. The platen 1704 can receive graphical indicators.

Now referring to FIG. 17B, depicted is an embodiment of the platen 1704 receiving a grid 1706 for aligning a garment. The grid 1706 can be a series of intersecting straight or curved lines use to structure the platen 1704. The grid 1706 can be a framework for aligning objects on the platen 1704. The grid 1706 can be in a uniform pattern, or any structured geometric pattern having predetermined parameters. For instance, the grid 1706 can represent a coordinate system of pixels. Different pixels can have different spacing. For instance, the lines on the grid 1706 can be spaced 1 cm or 1 inch apart. In some embodiments, the grid 1706 can include lines or indicators corresponding to objects disposed on the platen 1704. The lines or indicators can correspond to expected objects based on the order specifications from the order analyzer 108. Now referring to FIG. 17C, depicted is an embodiment of the grid 1706 having a collar line 1708 corresponding to a collar of garments to be disposed on the platen 1704. By depicting the collar line 1708 on the grid 1706, garments can align on the platen 1704 by a user, a robot, or the manufacturer 112.

Now referring to FIG. 17D, depicted is an embodiment of a sensor 1710 for projecting the grid 1706 on the platen 1704. The sensor 1710 can include a structured light 1711. The light 1711 can emit any suitable wavelength or beam size of light to display the grid 1706. For instance, the light 1711 can emit lasers to project the lines of the grid 1706 on the platen 1704. In some embodiments, the computing platform 308 interfaces with the sensor 1710. For instance, the image receiver 608 of the computing platform 308 can receive measurements or images of platen 1704. Similarly, the calibrator 610 of the computing platform 308 can calibrate the position of the grid 1706 on the platen 1704. The code detector 612 can determine when an object is disposed on the platen 1704. The horizontal axis combiner 614, image aligner 616, vertical axis combiner 618, and the partial image combiner 620 can generate an image of the platen 1704 and any garments disposed thereof. Based on the grid 1706, the sensor 1710 can acquire alignment measurements corresponding to an alignment of objects on the platen 1704. The sensor 1710 can transmit the alignment measurements to the computing platform 308. The image parameter extractor 624 can determine an alignment of the object on the platen 1704 from the alignment measurements. The manufacturer 112 can load the objects on the platen 1704 based on the alignment. Based on the alignment of the object, the router controller 630 can request the sensor 1710 to change the color of the grid 1706. For instance, if an object's alignment satisfies a predetermined threshold, the router controller 630 can request the sensor 1710 to emit a green grid 1706. In contrast, if the object's alignment fails to satisfy the predetermined threshold, the router controller 630 can request the sensor 1710 to emit a red grid 1706. In some embodiments, the platen 1704 can align objects with the grid 1706.

The sensor 1710 can also generate measurements corresponding to the surface flatness of objects disposed on the platen 1704. By determining a surface flatness of the object on the platen 1704, the manufacturer can 112 prevent manufacturing defects. The sensor 1710 can acquire the surface flatness by generating a topography of the object on the platen 1704. The sensor 1710 can acquire surface flatness measurements corresponding to a surface flatness of objects on the platen 1704. The sensor 1710 can transmit the surface flatness measurements to the computing platform 308. The image parameter extractor 624 can determine a surface flatness of the object on the platen 1704. For instance, the heat press 1610 and the printer 1612 can print on flat garments while rejecting jagged garments. Based on the surface flatness, the router controller 630 can indicate whether the object can proceed to the heat press 1610 or the printer 1612. For instance, the router controller 630 can route the object to the heat press 1610 or the printer 1612 if the surface flatness satisfies a threshold. If the surface flatness fails to satisfy the threshold, the router controller 630 can route the object to the pretreat 1604 or the dryer 1608. In some embodiments, if the surface flatness fails to satisfy the threshold, the router controller 630 can route the object for disposal. In some embodiments, if the surface flatness fails to satisfy the threshold, the router controller 630 can request that the lid 1702 flatten or iron the object on the platen 1704.

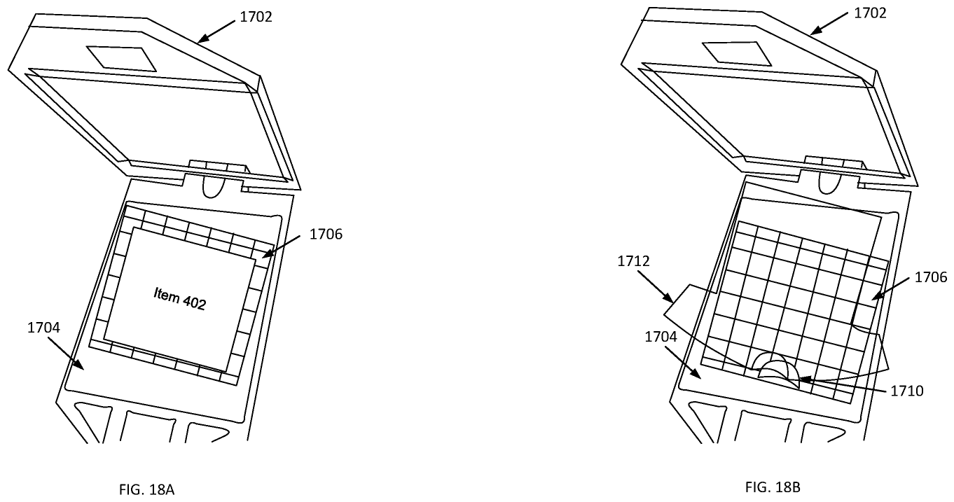

Now referring to FIG. 18A, depicted is an embodiment of the grid 1706 overlaid on the item 402 disposed on the platen 1704. The item 402 can slide on the platen 1704. In some embodiments, adhesive can stick the item 402 to the platen 1704. The item 402 can attach to an attachment mechanism on the platen 1704. The grid 1706 can provide an alignment reference for positioning the item 402. Now referring to FIG. 19A, depicted is an embodiment of the grid 1706 overlaid on the item 402. For instance, the manufacturer 112 can position the item 402 in the center of the platen 1704 based on the spacing of the grid 1706.

Now referring to FIG. 18B, depicted is an embodiment of the grid 1706 overlaid on a shirt 1712 disposed on the platen 1704. The shirt 1712 can slide on the platen 1704. In some embodiments, adhesive can stick the shirt 1712 to the platen 1704. The shirt 1712 can attach to an attachment mechanism on the platen 1704. The grid 1706 can provide an alignment reference for positioning the shirt 1712. Now referring to FIG. 19B, depicted is an embodiment of the shirt 1712 on the projection mat. For instance, the manufacturer 112 can position the shirt 1712 in the center of the platen 1704 based on the spacing of the grid 1706. The collar line 1708 on the grid 1706 can align the collar of the shirt 1712 with the platen 1704. The grid 1706 and the collar line 1802 can be an alignment guide for loading the shirt 1712.

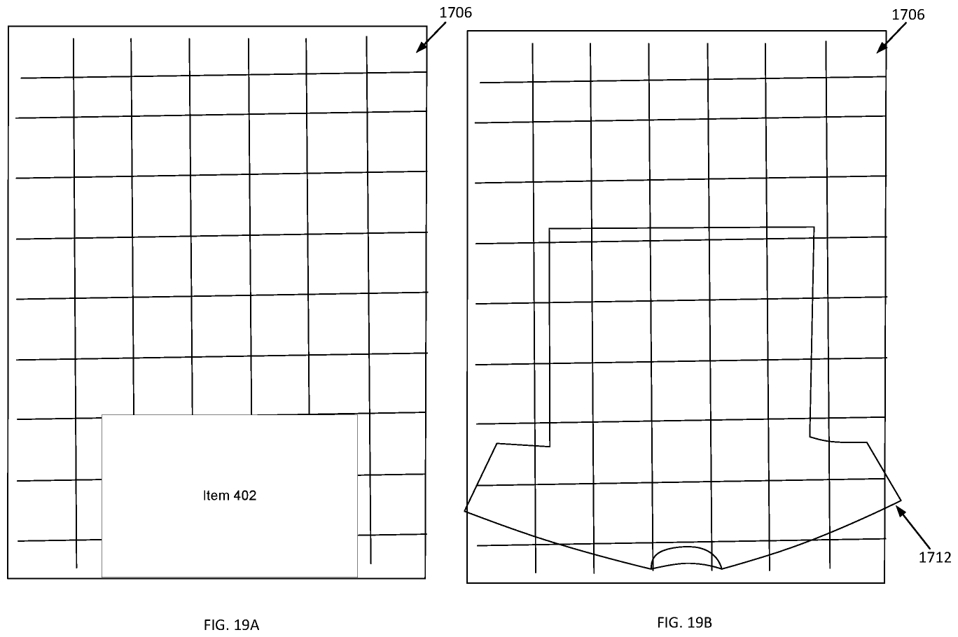

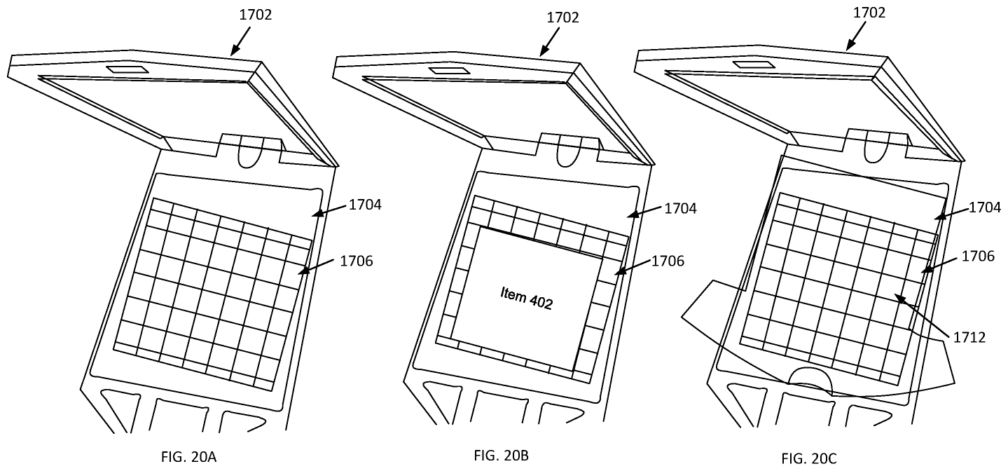

Now referring to FIG. 20A, depicted is an embodiment of the lid 1702 closing over the platen 1704. The lid 1702 may include a hinge, a mechanical or hydraulic device, or any other mechanism for maneuvering the lid 1702 over the platen 1704. In some embodiments, the lid 1702 can slide or rotate over the platen 1704. The lid 1702 can be user operated or battery operated. The manufacturer 112 can automatically close the lid 1702 responsive to the sensor 1710 detecting an object secured on the platen 1704. In some embodiments, the lid 1702 can attach to the platen 1704 via a lock, adhesive, or any other locking mechanism. Similarly and now referring to FIG. 20B, depicted is an embodiment of the lid 1702 closing over the platen 1704 having the item 402. In some embodiments, the lid 1702 closes over the platen 1704 responsive to the sensor 1710 detecting that the item 402 is fastened to the platen 1704. Similarly and now referring to FIG. 20C, depicted is an embodiment of the lid 1702 closing over the platen 1704 having the shirt 1712. In some embodiments, the lid 1702 closes over the platen 1704 responsive to the sensor 1710 detecting that the item 402 is fastened to the platen 1704 and not interfering with any of the hinges or moving parts of the lid 1702.

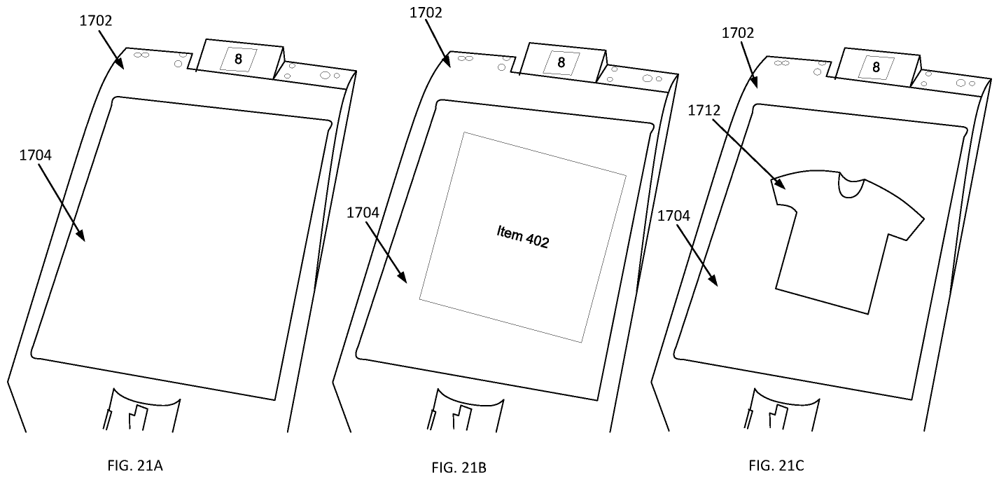

Now referring to FIG. 21A, depicted is an embodiment of the lid 1702 closed over the platen 1704. The lid 1702 can attach to the platen 1704. The lid 1702 closed over the platen 1704 can secure objects disposed on the platen 1704. In some embodiments, the sensor 1710 can turn off the grid responsive to the lid 1702 closing over the platen 1704. Similarly and now referring to FIG. 21B, depicted is an embodiment of the lid 1702 closed over the platen 1704 having the item. The lid 1702 can secure the item 402 to the platen 1704. In some embodiments, once the lid 1702 closes over the platen 1704, the sensor 1710 can analyze the item 402. Similarly and now referring to FIG. 21C, depicted is an embodiment of the lid 1702 closed over the platen 1704 having the shirt 1712. In some embodiments, the entire shirt 1712 can be on the platen 1704. In alternate embodiments, parts of the shirt 1712 hang off the sides of the platen 1704. In some embodiments, once the lid 1702 closes over the platen 1704, the sensor 1710 can analyze the shirt 1712. The closed lid 1702 can allow the platen 1704 to maneuver the item 402, the shirt 1712, or any other object to the heat press 1610 or the printer 1612.

Now referring back to FIG. 16 and in further detail, the heat press 1610 can heat and press the materials. The heat press 1610 can imprint a design or graphic on the materials. For instance, the heat press 1610 can imprint on a t-shirt, mugs, plates, jigsaw puzzles, caps, and other products. The heat press 1610 can imprint by applying heat and pressure for a predetermined time based on the design and the material. The heat press 1610 can include controls for temperature, pressure levels, and time of printing. To imprint the graphic, the heat press 1610 can employ a flat platen to apply heat and pressure to the substrate. The flat platen can be above or below the material, in some embodiments resembling a clamshell. In some embodiments, the flat platen can be a Clamshell (EHP), Swing Away (ESP), or Draw (EDP) design. The heat press 1610 can include a combination of the flat platen designs, such as Clamshell/Draw or a Swing/Draw Hybrid. For instance, the heat press 1610 can include an aluminum upper-heating element with a heat rod cast into the aluminum or a heating wire attached to the element. The heat press 1610 can also include an automatic shuttle and dual platen transfer presses. The heat press 1610 can include vacuum presses utilizing air pressure or a hydraulic system to force the flat platen and materials together. The heat press 1610 can set the air pressure based on predetermined high psi ratings. For instance, the heat press 1610 can imprint by loading materials onto the lower platen and shuttling them under the heat platen, where heat and pressure imprint the design or graphic. In some embodiments, the heat press 1610 can transfers the design or graphic from sublimating ink on sublimating paper. The heat press 1610 can include transfer types such as heat transfer vinyl cut with a vinyl cutter, printable heat transfer vinyl, inkjet transfer paper, laser transfer paper, plastisol transfers, and sublimation. In some embodiments, the heat press 1610 can include rotary design styles such as roll-to-roll type (ERT), multifunctional type (EMT), or small format type (EST).

Still referring to FIG. 16 and in further detail, the printer 1612 can print on the materials. The printer 1612 can print the heat pressed materials based on the specifications of each item in the order. The printer 1612 can use screen-printing or direct to garment printing technology (DTG). The printer 1612 can print on materials using aqueous ink jets. The printer 1612 can include a platen designed to hold the materials in a fixed position, and the printer 1612 can jet or spray printer inks onto the materials via a print head. The platen can be similar to the platens discussed in reference to the heat press 1610. The printer 1612 can print on materials pretreated by the pretreat 1604. The printer 1612 can include water-based inks. The printer 1612 can print on any of the materials selected by the materials selector 1602. The printer 1612 may apply the ink based on the materials, such one type of application for natural materials, and another type of application for synthetic materials.

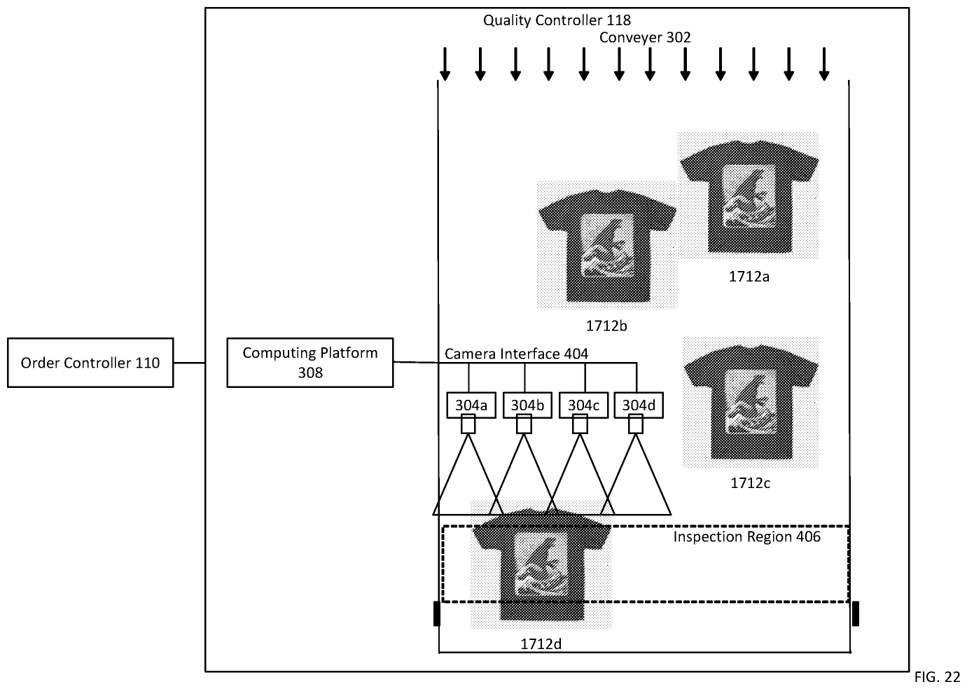

Now referring to FIG. 22, depicted is an embodiment the lateral transport mechanism 302 carrying garments for analysis in in the inspection region. For instance, the lateral transport mechanism 302 can carry shirts 1712a-1712d (generally referred to as shirts 1712) into the inspection region 406. The shirts 1712 can be an embodiment of the items 402. The manufacturer 112, as similarly discussed in reference to FIG. 16, may have made the shirts 1712. The shirts 1712 can be any other garment, such as pants, socks, or hats. The cameras 304 can image the shirts 1712 for defects. The lateral transport mechanism 302 can convey the shirts 1712 beneath the cameras 304 along an axis parallel to the direction of travel of the lateral transport mechanism 302. The camera 304 can obtain images of the shirts 1712 for analysis by the computing platform 308. For instance, the cameras 304 can image the shirt 1712d in the inspection region 406. The computing platform 308 can image any part of the shirt 1712, such as fabric or the print. For instance, the computing platform 308 can analyze whether the monster depicted in the shirt 1712d has accurate dimensions and colors.

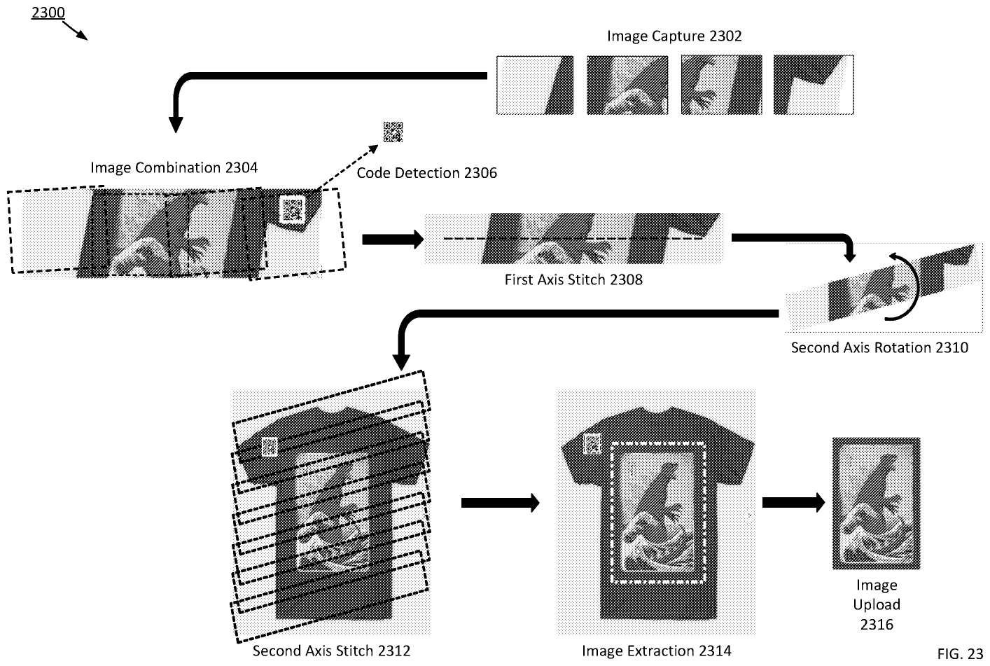

Now referring to FIG. 23, depicted is an embodiment of a flow 2300 of the computing platform 308 for analyzing garments. The computing platform 308 can analyze images of the shirts 1712. The flow 2300 can include image capture 2302, image combination 2304, code detection 2306, first axis stitching 2308, a second axis rotation 2310, a second axis stitch 2312, an image extraction 2314, and an image upload 2316.

Still referring to FIG. 23 and in further detail, the image capture 2302 can include the image receiver 608, as previously discussed, detecting images of the inspection region 406, such as images of the shirts 1712. The image combination 2304 can include the horizontal axis combiner 614, as previously discussed, combining the images of the shirt 1712. The code detection 2306 can include the code detector 612, as previously discussed, detecting the code on the shirt 1712. The first axis stitching 2308 can include the horizontal axis combiner 614, as previously discussed, stitching the images along an axis. The second axis rotation 2310 can include the image aligner 616, as previously discussed, aligning the images along the second axis. The second axis stitch 2312 can include the vertical axis combiner 618, as previously discussed, combining the horizontal portions of the shirt 1712 into partial images of the shirt 1712, which the partial image combiner 620 can combine into an image of the shirt 1712.

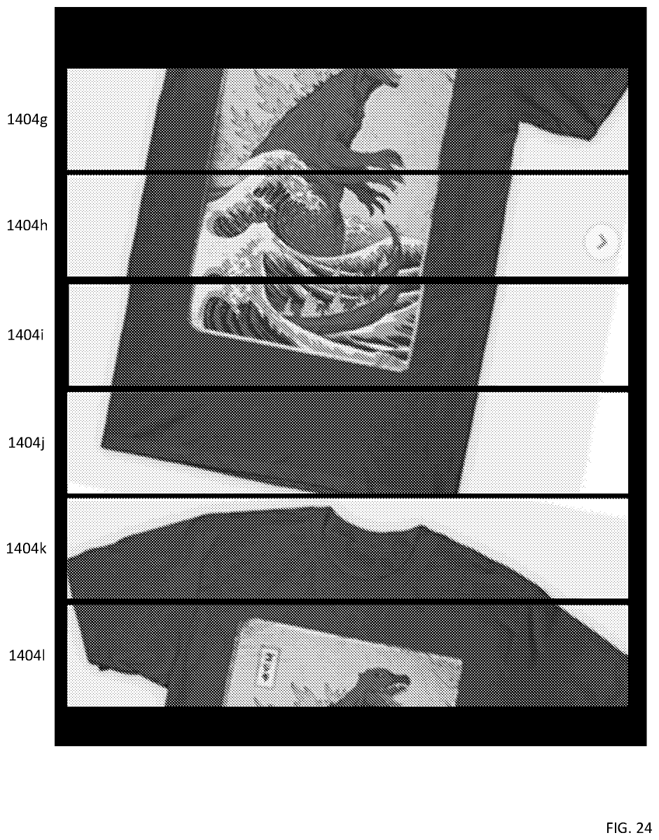

Now referring to FIG. 24, depicted is an embodiment of the image buffer for horizontal portions of the garments, such as the shirts 1712. As previously discussed, the image buffer 1402 of the vertical axis combiner 618 receives horizontal portions of items. As shown in FIG. 23, the image buffer 1402 includes horizontal portions 1402g-1402j of a first shirt 1712, and horizontal portions 1404k and 1404j of a second shirt 1712. The vertical axis combiner 618 can reconstruct horizontal portions 1404 from the image buffer 1402 into an image of the shirt 1712.

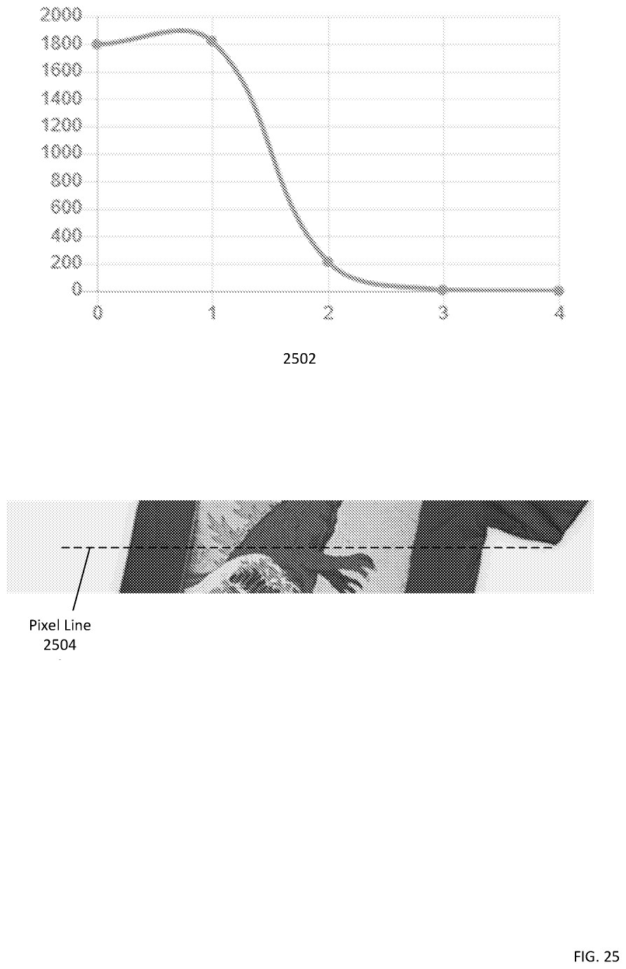

Now referring back to FIG. 23 and in further detail, the image extraction 2314 can include the analysis selector 622, as previously discussed, identifying a portion of the image, such as the monster in the shirt 1712. The image extraction 2314 can also include the image parameter extractor 624 analyzing the shirt 1712. Now referring to FIG. 25, depicted is an embodiment of an image histogram 2502 for indicating parameters of the garment image. For instance, the image histogram 2502 can indicate a pixel line 2504 of the shirt 1712. As previously discussed, the image parameter extractor 624 can generate an image histogram depicting the color distribution of the image by the number of pixels for each color value. As shown in FIG. 25, the image histogram 2502 depicts the pixel line 2504 of the shirt 1712. The image parameter extractor 624 can generate an image histogram for each line of pixels along the image of the shirt 1712.

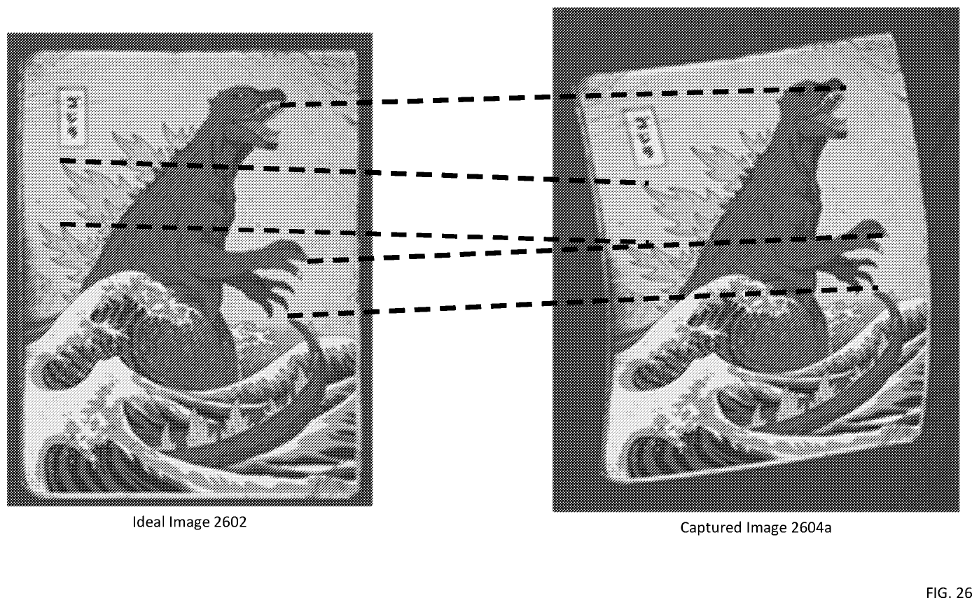

The image extraction 2314 can also include the image comparator 626 comparing the parameters of the shirt 1712 to reference parameters. Now referring to FIG. 26, depicted is an embodiment of a comparison for identifying defects in the garment based on a reference design. The ideal image 2602 includes the reference image of the shirt 1712, such as the monster image. As previously discussed, the reference image can be stored in the electronic storage 606, analyzed by the image parameter extractor 624, and retrieved by the image comparator 626. The image comparator 626 can similarly retrieve the captured image 2604a from the analysis selector 622 and the parameters of the captured image 2604a from the image parameter extractor 624. The image comparator 626 can compare parameters between the ideal image 2602 and the captured image 2604a, such as the parameters corresponding to the monster's teeth, fires, claws, and tail. For instance, the image comparator 626 can compare the image histograms of the pixels in the aforementioned portions. If the image histograms are different, then the shirt 1712 is different from the reference and thus may have defects.

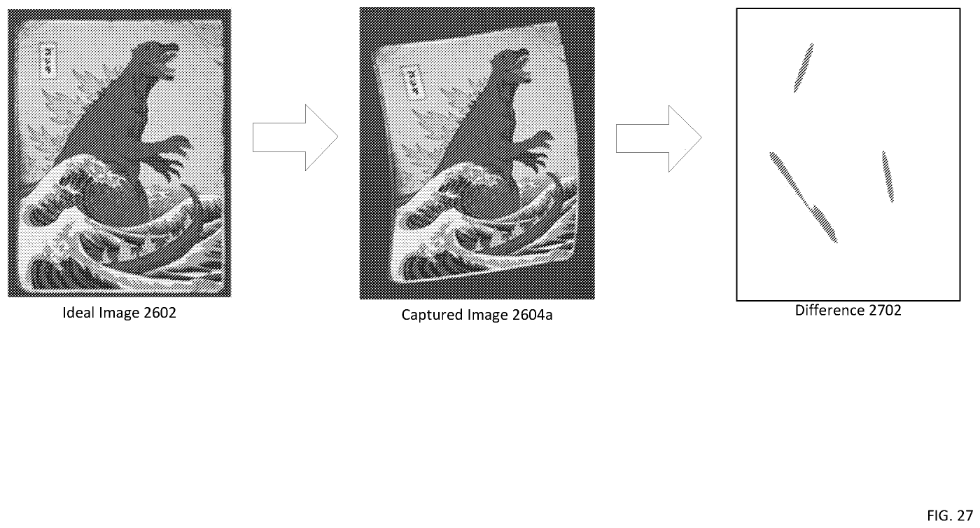

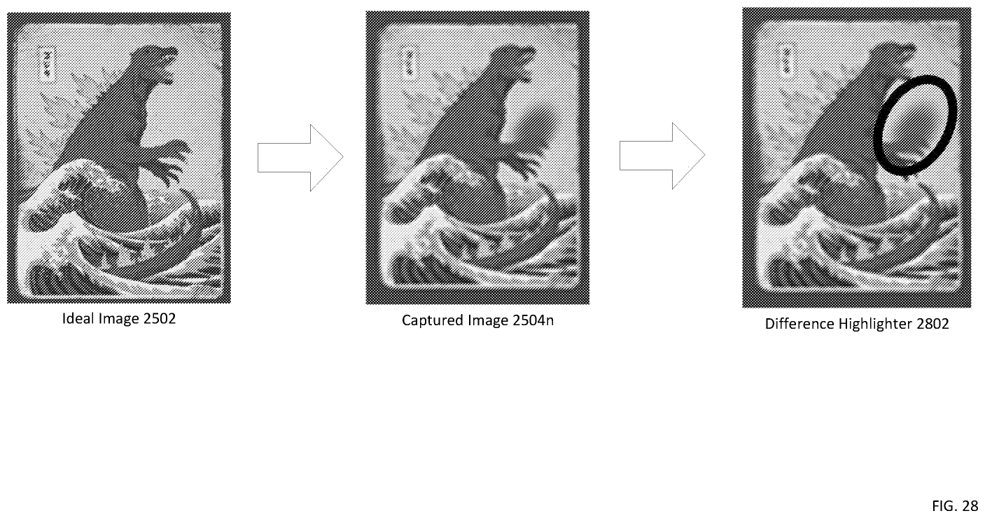

The image comparator 626 can identify the differences between the ideal image 2602 and the captured image 2604a. Now referring to FIG. 27, depicted is an embodiment of a comparison for indicating differences between the garments image and the reference image. For instance, a difference image 2702 indicates differences between the ideal image 2602 and the captured image 2604a. The difference image 2702 indicates portions of the captured image 2604a that have different features from the ideal image 2602. The different features can be colors, threads, rips, or dimensions. The order controller 110 can access the difference image 2702 to determine where the defects are and to adjust the manufacturing process of the shirt 1712. Now referring to FIG. 28, depicted is an embodiment of a difference highlighter highlighting differences between the reference image and the captured image. For instance, a difference highlighter 2802 highlights differences between the ideal image 2602 and the captured image 2604n. As shown in FIG. 28, an embodiment of the captured image 2604n includes a smudge in the middle-right, near the claws of the monster. Based on the analysis of the captured image 2104, the image comparator 626 can generate the difference highlighter 2802 depicting the differences between the ideal image 2602 and the captured image 2604n. The order controller 110 can access the difference highlighter 2802 to determine where the defects are and to adjust the manufacturing process of the shirt 1712.

Now referring back to FIG. 23 and in further detail, the image upload 1916 can include the item image transmitter 628, as previously discussed, transmitting the image of the shirt 1712, such as the captured images 2504a-2504n to the order controller 110. The image upload 2316 can also include the image transmitter 628 transmitting the difference image 2702 or the difference highlighter 2802 to the order controller 110.

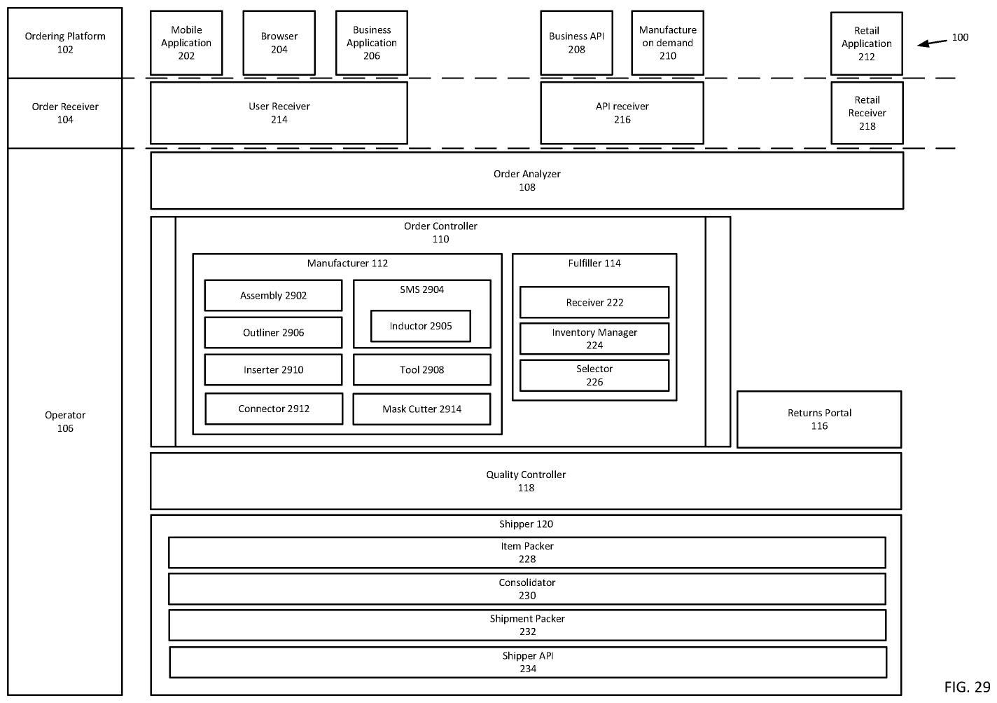

Now referring to FIG. 29, depicted is an embodiment of the system 100 configured for scanning masks at the point of manufacturing. The manufacturer 112 can include an assembly 2902 assembling the materials for manufacturing masks. The manufacturer 112 can include a spun bound-melt blown-spun bound (SMS) 2904 making fabric for the masks. The manufacturer 112 can include outliner 2906 forming outlines of the masks. The manufacturer 112 can include a tool 2908 welding and cutting the mask materials. The manufacturer 112 can include an inserter 2910 inserting objects into the mask. The manufacturer 112 can include a connector 2912 connecting attachment mechanisms to the mask. The manufacturer 112 can include a mask cutter 2914 cutting out the mask.

Still referring to FIG. 29 and in further detail, the assembly 2902 can assemble the materials for manufacturing masks. The assembly 2902 can receive fabric suitable for manufacturing masks. The fabric can be package and unwoven. The assembly 2902 can feed the materials into the SMS 2904.

Still referring to FIG. 29 and in further detail, the SMS 2904 can make the fabric for the masks. The SMS 2904 can receive a fabric material. The fabric material can be a fiber or a filament. The SMS 2904 can receive input specific requirements to create fabric having certain characteristics. The SMS 2904 can control fiber diameter, quasi-permanent electric field, porosity, pore size, high barrier properties of the materials. The SMS 2904 can also control the temperatures, fluid pressures, circumferential speeds, feed rate of liquefied polypropylene melt to adjust the size of the fiber. The SMS 2904 can vary collector vacuum pressure differential to ambient pressure. The fabric material can have reactor-granule-polypropylene. By using a reactor granule polypropylene, the SMS 2904 can form at commercially acceptable polymer melt throughputs. The SMS 2904 can create a fabric having a web shape with an average fiber size of from 0.1 to 8 microns, and pore sizes distributed predominantly in the range from 7 to 12 microns.

The SMS 2904 can maintain a consistent index of the multi component fabrics via a proprietary web control mechanism. The SMS 2904 can assemble the multi component fabrics continuously. The SMS 2904 can adjust the additive ratios to the polypropylene formulations. The SMS 2904 can add magnesium stearate or barium titanate to the fabric material. The SMS 2904 can control the crystal structure of the fabric material based on the additives. The SMS 2904 can induce controllable physical entanglement of the fibers. The SMS 2904 can mix additives to create PP/MgSt mixtures, which can increase the filtration efficiency of the fabric. The additives can increase melt flow rate and lowers viscosity of the fabric. The SMS 2904 can introduce a nucleating agent into the PP polymer during the melt blown process, which can improve the electret performance of the resultant nonwoven filter. The SMS 2904 can assemble the mask material into a fluffy and high porosity structure, such as, for instance, by regulating the Die-to-Collector Distance (DCD) between 10 cm to 35 cm. The SMS 2904 can regulate the DCD to create a fluffy nonwoven filter with consistent diameter, small pore size, and high porosity. The assembly can prevent changes to the fiber diameter if the fiber drawing process occurs in a close region near the face of the die.

The SMS 2904 can manufacture a three component non-woven fabric. The SMS 2904 can manufacture each component of the non-woven fabric separately. The SMS 2904 can include first spinner manufacturing a first layer of the fabric, a blower manufacturing a second layer of the fabric, and a second spinner manufacturing a third layer of the fabric. The fabric material can include a melt blown nonwoven having characteristics of a fibrous air filter. The melt blown nonwoven can have a high surface area per unit weight, high porosity, tight pore size, and high barrier properties.

The SMS 2904 can control the web, tensioning, and flow of the fabric materials. The SMS 2904 can create melt blown nonwoven from fine fibers, such as between 0.1-8 microns, based on polymer fiber spinning, air quenching/drawing, and web formation. The SMS 2904 can manufacture fibrous layers having a nonwoven web structure. The SMS 2904 can receive fibers from the assembler. The SMS 2904 can spin the fibers into a first fibrous layer. The SMS 2904 blow the fibers into a second fibrous layer. The SMS 2904 can include an electrode 2905. The SMS 2904 can blow the second fibrous layer adjacent to the electrode 2905. The electrode 2905 can induce a Corona discharge and polarization of the second fibrous layer on the electrostatic field. The electrode 2905 can also store electric charges and create a quasi-permanent electric field on the periphery of the second fibrous layer. The electrode 2905 can change the size of the fibers by applying electric field strengths from 10 KV to 45 KV. The electrode 2905 can create a second fibrous layer having electric melt blown filters, which can filter 99.997% of 0.3 Micron sized particles by electrostatic force. The SMS 2904 can also assemble electret polypropylene melt blown air filtration materials having nucleating agents for PM2.5 capture. The SMS 2904 can use the electrode 2905 to reduce the average diameter of the melt-blown fibers, such as from 1.69 μm to 0.96 μm. The SMS 2904 can receive the first fibrous layer and then combine the first fibrous layer and the second fibrous layer into a dual layer.

The SMS 2904 can form a mask material having nonwoven web structure from the fibers. In some embodiments, the SMS 2904 can form the mask material into the nonwoven web structure from the first layer and the second layer responsive to responsive to the Corona discharge and the polarization. The SMS 2904 can spin the fibers into a third fibrous layer. The SMS 2904 can receive the dual layer and then combine the dual layer and the third fibrous layer to form a tri-layer fabric or the three component non-woven fabric. The SMS 2904 can make the mask material have a fiber diameter of 0.96 micrometers. In some embodiments, the SMS 2904 can make the mask material have a fiber diameter of 0.96 micrometers responsive to the Corona discharge and polarization. The SMS 2904 can also form the mask material to have a fiber size between 0.1 to 8 microns, and a pore size between 7 and 12 microns. The SMS 2904 can generate fabrics in relation to direct to garment printing with repeatability of 100 microns. The SMS 2904 can design multiple scale variants with parametric closed form design formulations.

Still referring to FIG. 29 and in further detail, the outliner 2906 can form outlines of the masks. The outliner 2906 can receive fabrics manufactured by the SMS 2904. The outliner 2906 can outline medical masks, consumer masks, or garment masks. The outliner 2906 can dispose the mask material along a mask grove form of a mask outline. The mask outline can have a first lateral edge that is distal to a second lateral edge, and a first horizontal edge that is distal to a second lineal edge. For instance, the mask outline can be an oval. The oval can be associated with the shape of a human face.

Still referring to FIG. 29 and in further detail, the tool 2908 can weld and cut the mask materials. The tool 2908 can machine the mask material along the first lateral edge and the second lateral edge. Machining along the edges can reinforce the mask materials. The tool 2908 can drill a first hole in the mask material adjacent to the first lateral edge and a second hole in the mask material adjacent to the second lateral edge. The hole can receive an object, such as a wire to allow the mask to attach to a user. The tool 2908 can weld the first lateral edge into a first welded lateral edge, the second lateral edge into a second welded lateral edge, the first hole into a first welded hole, and the second hole into a second welded hole. Welding the edges and holes can reinforce and prevent the fabric from disintegrating. The tool 2908 can machine the mask material along the first lineal edge and the second lineal edge. The tool 2908 can cut out an incision in the mask material parallel to the first lineal edge. The incision can receive an object within the mask, such as structural support. The tool 2908 can weld the first lineal edge into a first welded lineal edge, the second lineal edge into a second welded lineal edge, and the incision into a welded incision. The tool 2908 can weld the incision to maintain the structural support within the mask.

Still referring to FIG. 29 and in further detail, the inserter 2910 can insert objects into the mask. For instance, the inserter 2910 can insert structural wires through the incision. The structural wires can prevent the mask from bending or losing its shape. The inserter 2910 can insert metal wires or plastic pillars.

Still referring to FIG. 29 and in further detail, the connector 2912 can connect attachment mechanisms to the mask. For instance, the connector 2912 can inserting an attachment wire through the first welded hole and the second welded hole. The attachment wire can be a rubber band or string that allows a user to wear the mask around their face. Similarly, the connector 2912 can connect a hook and loop fastener or adhesive to the mask.

Still referring to FIG. 29 and in further detail, the mask cutter 2914 can cut out the mask. For instance, the mask cutter 2914 can receive the mask having ear holes, structural wires, welds, and cuts, as previously discussed. The mask cutter 2914 can receive a continuous roll of masks from the connector 2912, and cut out each mask. For instance, the mask cutter 2914 can refine the mask and cut it out of the roll of masks for individual use. In some embodiments, the mask cutter 2914 can machining the mask material along the first welded lateral edge, the second welded lateral edge, the first welded lineal edge, the second welded lineal edge, the welded incision, the first welded hole, and the second welded hole.

In some embodiments, the manufacturer 112 can print on the masks. The manufacturer 112 can print a design, instructions, or any other information. For instance, the manufacturer 112 can print on the masks by using the heat press 1610 or the printer 1612, as previously discussed.

The quality controller 118 can determine whether the masks satisfy quality thresholds. The quality controller 118 can analyze the fabric or the construction of the mask, such as the welds and cuts. In some embodiments, the quality controller 118 receives the fabric from the SMS 2904. The quality controller 118 can capture images of the masks in the inspection region 406, analyze it by the computing platform 308, and provide preceptory feedback in regards to the quality of the fabric. For instance, the quality controller 118 can generate a scan of the masks, such as by the computing platform 308. In some embodiments, the image receiver 608, as previously discussed, receives images of the masks. The code detector 612 can detect a code associated with the mask. The horizontal axis combiner 614 can combine the images of the masks along a horizontal axis. The image aligner 616 can align combined images of the masks. The vertical axis combiner 618 can combine the aligned images into a partial image. The partial image combiner 620 can combine the partial images into an image of the entire mask or set of masks. The analysis selector 622 can select which part of the mask or fabric to analyze. The quality controller 118 can generate, based on the scan, comparisons between the mask material and predetermined mask parameters. The image parameter extractor 624 can extract parameters associated with the mask such as fiber dimensions, fiber size, fiber pore size, or incision sizes. The image comparator 626 can compare the parameters to reference parameters, and determine whether the masks satisfy quality thresholds. The quality controller 118 can return the mask material to the manufacturer 112 based on the comparisons. For instance, the SMS 2904 can fix mask defects by machining, based on the comparisons, the mask material along the first welded vertical edge, the second welded vertical edge, the first welded horizontal edge, or the second welded horizontal edge.

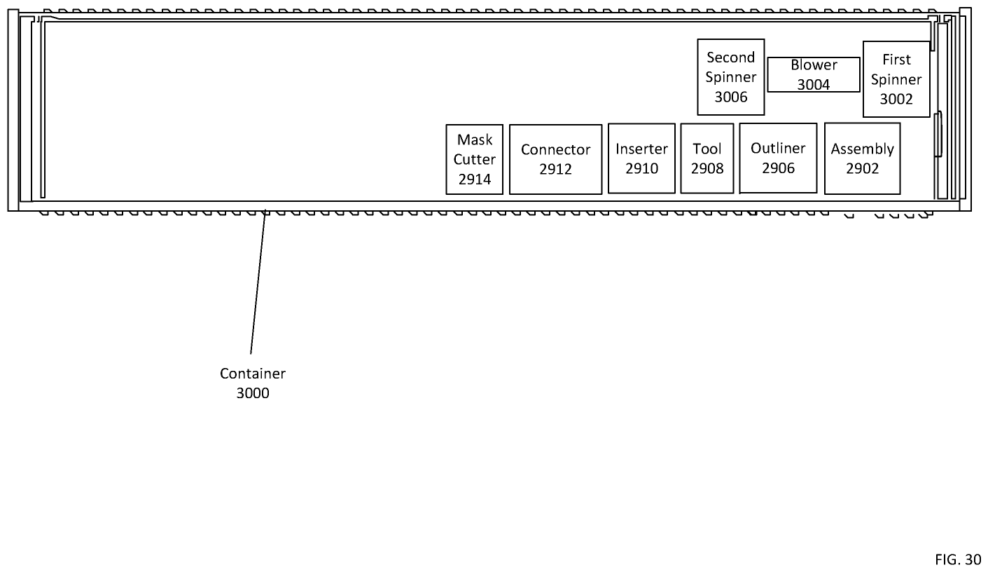

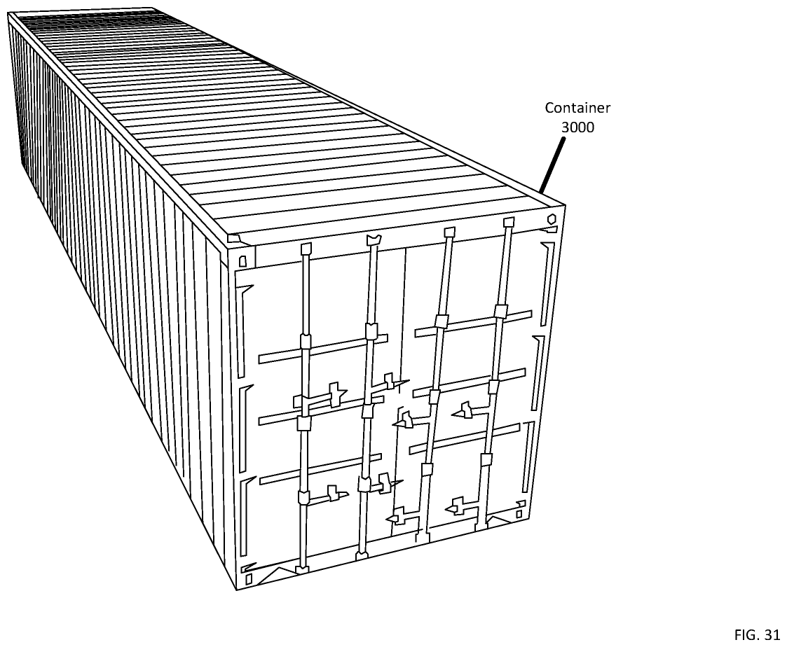

Now referring to FIG. 30, depicted is an embodiment of a container 3000 for containing the manufacturer 112 discussed in reference to in FIG. 29. The container 3000 can include a continuous production of masks. The container 3000 can include the assembly 2902 receiving materials from the side of the container 3000. The container 3000 can include the SMS 2904 as three components, the first spinner 3002, the blower 3004, and the second spinner 3006. The three components depict the spun bound-melt blown-spun bound implementation of the SMS 2904. The container 3000 can include the outliner 2906 receiving the fabric from the SMS 2904 to outline the masks. The container 3000 can include the tool 2908 receiving the fabric from the grove forms to cut and weld the fabric. The container 3000 can include the inserter 2910 inserting structural support wires into the fabric received from the tool 2908. The container 3000 can include the connector 2912 adding connectors to the fabric received from the inserter 2910. The mask cutter 2914 can cut out and refine individual masks from the fabric received from the connector 2912. In some embodiments, the container 3000 can include the quality controller 118 (not pictured). The quality controller 118 can provide quality feedback within the container 3000 to adjust the manufacturing process.

Now referring to FIG. 31, depicted is an enclosure of the container for containing the system configured for manufacturing masks. The container 3000 can be a shipping container. The container 3000 can include an alloy-based construction such as steel. The container 3000 can be 40 feet long, 8 feet wide, and 8.5 feet tall.

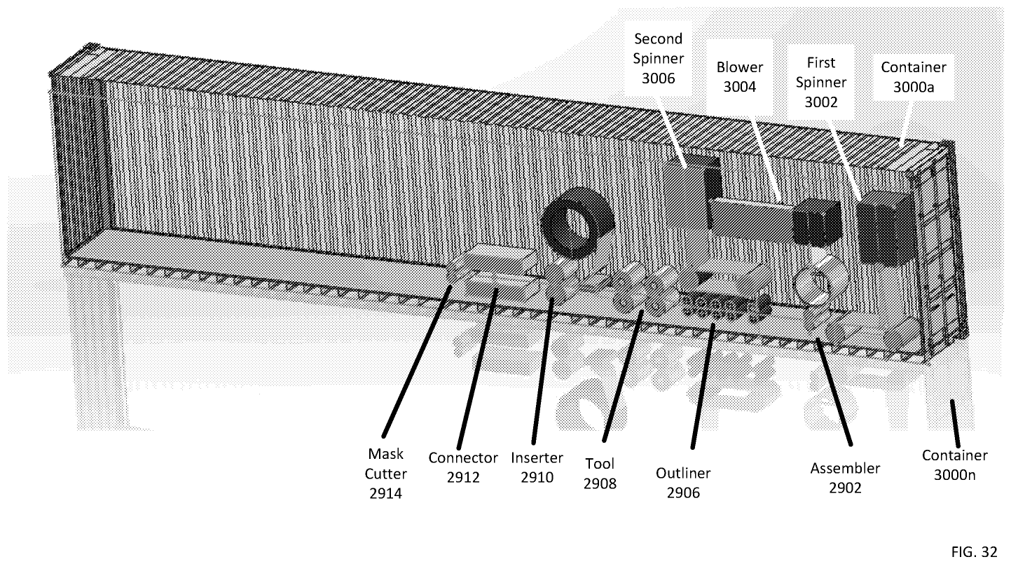

Now referring to FIG. 32, depicted is an embodiment for containing the system configured for scanning masks at the point of manufacturing. The container 3000a can include the system discussed in reference to FIGS. 29-31. The container 3000a can include an energy provider to power the manufacturer 112 or the quality controller 118. The energy provider can include a generator or solar panels mounted on the outside of the container 3000a. The container 3000a can include a water hook up, internet connection, materials port, or any other connection to facilitate the manufacturing of masks. By having the entire manufacturing and quality control process in the container 3000a, the system described herein can rapidly deploy anywhere in the world during any natural disaster to provide emergency mask manufacturing and quality control. For instance, emergency personnel can deliver the container 3000a to a field hospital for rapid manufacture of high-quality masks for medical staff. Additionally, the containers 3000a-3000n can scale the system described herein. The container 3000a and container 3000n are stacked together and share materials or resources. For instance, the energy provider of one container can share electricity, internet, or water with other containers. By efficiently scaling the manufacturing process of masks, the system described therein can mitigate resource limitations typically present during an emergency or natural disaster.

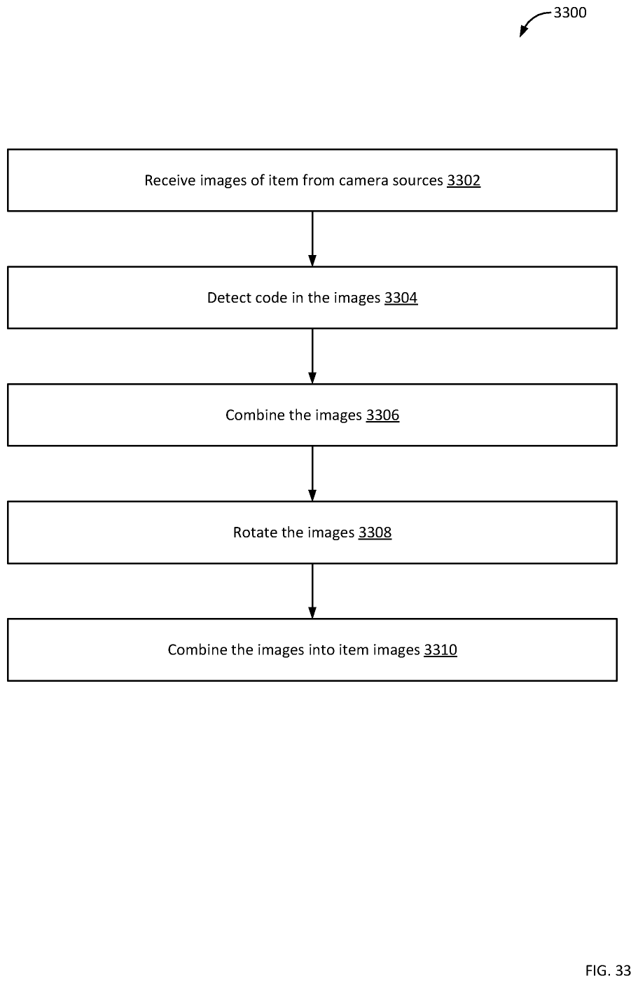

Now referring to FIG. 33 illustrates a method 3300 for scanning items at the point of manufacturing, in accordance with one or more implementations. The operations of method 3300 presented below are intended to be illustrative. In some implementations, method 3300 may be accomplished with one or more additional operations not described, and/or without one or more of the operations discussed. Additionally, the order in which the operations of method 3300 are illustrated in FIG. 33 and described below is not intended to be limiting.

In some implementations, method 3300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 3300 in response to instructions stored electronically on an electronic storage medium. The one or more processing devices may include one or more devices configured through hardware, firmware, and/or software to be specifically designed for execution of one or more of the operations of method 3300.

An operation 3302 may include receiving images of the item 402 from cameras 304. Operation 3302 may be performed by one or more hardware processors configured by machine-readable instructions including the computing platform 308, in accordance with one or more implementations. The items 402 can arrive from the order controller 110. The item 402 may traverse beneath the camera 304 along a first axis. The operation 3302 can receive images of the item 402. The operation 3302 can receive a second set of images of the item from a second set of camera sources. In some embodiments, the operation 3302 receives, responsive to detecting the code, a second set of images of the item from a second set of camera sources. In some embodiments, the item 402 traverses beneath the second set of camera sources 304 along the first axis. The operation 3302 can receive a set of calibration images of a calibration item from the first set of camera sources. The calibration item can have a predetermined calibration parameter. The operation 3302 can calibrate, the combining and the rotating of images based on the predetermined calibration parameter.

An operation 3304 may include detecting a code in the images. Operation 3304 may be performed by one or more hardware processors configured by machine-readable instructions including the computing platform 308, in accordance with one or more implementations. The operation 3304 can detect the code and the code may have a unique item identifier.

An operation 3306 may include combining the images. Operation 3306 may be performed by one or more hardware processors configured by machine-readable instructions including the computing platform 308, in accordance with one or more implementations. The operation 3306 can combine the images along a second axis. The operation 3306 can combine the images responsive to detecting the code. The operation 3306 can combine the images along a second axis perpendicular to the first axis. The first set of images into a first set of combined images. The operation 3306 can identify a first row of images of the first set of images. In some embodiments, the operation 3306 identifies the first row of images of the first set of images responsive to detecting the code. The first row of images can be disposed in sequence along the second axis perpendicular to the first axis. The operation 3306 can identify a second row of images of the first set of images. In some embodiments, the operation 3306 identifies a second row of images of the first set of images responsive to detecting the code. The second row of images can be disposed in sequence along the second axis.

The operation 3306 can combine the first row of images into a first combined row image of the first set of combined images. In some embodiments, the operation 3306 combines the first row of images into a first combined row image of the first set of combined images along the second axis. The operation 3306 can combine the second row of images into a second combined row image of the first set of combined images. In some embodiments, the operation 3306 combines, along the second axis, the second row of images into a second combined row image of the first set of combined images. The operation 3306 can combine the second set of images into a second set of combined images. In some embodiments, the operation 3306 combines, along the second axis perpendicular to the first axis, the second set of images into a second set of combined images.

The operation 3306 can identify a third row of images of the second set of images. The third row of images can be disposed in sequence along the second axis perpendicular to the first axis. In some embodiments, the operation 3306 identifies, responsive to detecting the code, a third row of images of the second set of images. The operation 3306 can identify a fourth row of images of the second set of images. The fourth row of images can be disposed in sequence along the second axis. The operation 3306 can combine the third row of images into a third combined row image of the second set of combined images. In some embodiments, the operation 3306 combines, along the second axis, the third row of images into a third combined row image of the second set of combined images. The operation 3306 can combine the fourth row of images into a fourth combined row image of the second set of combined images. In some embodiments, the operation 3306 combines, along the second axis, the fourth row of images into a fourth combined row image of the second set of combined images.

An operation 3308 may include rotating the images. Operation 3308 may be performed by one or more hardware processors configured by machine-readable instructions including the computing platform 308, in accordance with one or more implementations. Each of the combined images may be rotated into a first set of rotated images. The operation 3308 can rotate each of the second set of combined images into a second set of rotated images. In some embodiments, the operation 3308 can rotate, parallel to the first axis, each of the second set of combined images into a second set of rotated images.

An operation 3310 may include combining the images into item images. The first set of images may rotate images into a first partial item image. Operation 3310 may be performed by one or more hardware processors configured by machine-readable instructions including the computing platform 308, in accordance with one or more implementations. The operation 3310 can identify a first row of rotated images of the first set of rotated images. The first row of rotated images can be disposed along the second axis. The operation 3310 can identify a second row of rotated images of the first set of rotated images. The second row of rotated images can be disposed along the second axis. The operation 3310 can combine the first row of rotated images and the second row of rotated images into the first partial item image. In some embodiments, the operation 3310 can combine, along the second axis, the first row of rotated images and the second row of rotated images into the first partial item image. The operation 3310 can combine the second set of rotated images into a second partial item image. In some embodiments, the operation 3310 combines, along the first axis, the second set of rotated images into a second partial item image.

The operation 3310 can identify a third row of rotated images of the second set of rotated images. In some embodiments, the third row of rotated images are disposed along the second axis. The operation 3310 can identify a fourth row of rotated images of the second set of rotated images. In some embodiments, the fourth row of rotated images are disposed along the second axis. The operation 3310 can combine the third row of rotated images and the fourth row of rotated images into the second partial item image. In some embodiments, the operation 3310 can combine, along the second axis, the third row of rotated images and the fourth row of rotated images into the second partial item image. The operation 3310 can combine the first partial item image and the second partial item image into an item image. The operation 3310 can identify an ideal image from an image database. The ideal image can correspond to the code. The operation 3310 can extract an ideal image parameter from the ideal image. The operation 3310 can extract an item image parameter from the item image. The operation 3310 can generate a correlation score between the item image and the ideal image by comparing the item image parameter to the ideal image parameter.

The operation 3310 can transmit the item image to a server 602. In some embodiments, the operation 3310 can transmit, responsive to the correlation score satisfying a predetermined correlation threshold, the item image to a server 602. The operation 3310 can extract a sectional image parameter corresponding to an item image section of the item image. In some embodiments, the operation 3310 can extract, responsive to the correlation score satisfying the predetermined correlation threshold, a sectional image parameter corresponding to an item image section of the item image. The operation 3310 can compare, the sectional image parameter to the ideal image parameter to generate a sectional correlation score of the item image section. The operation 3310 can transmit the item image section having the sectional correlation score satisfying a predetermined sectional correlation score. In some embodiments, the operation 3310 can transmit, to the server 602, the item image section having the sectional correlation score satisfying a predetermined sectional correlation score.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for scanning items at the point of manufacturing comprising:
receiving a first set of images of an item from a first set of camera sources, the item traversing beneath the first set of camera sources along a first axis;
detecting a code in the first set of images, the code having a unique item identifier;
combining, responsive to detecting the code, along a second axis perpendicular to the first axis, the first set of images into a first set of combined images;
rotating parallel to the first axis, each of the first set of combined images into a first set of rotated images; and
combining along the first axis, the first set of rotated images into a first partial item image.

2. The method of claim 1, wherein combining, responsive to detecting the code, along the second axis perpendicular to the first axis, the first set of images into the first set of combined images comprises:
identifying, responsive to detecting the code, a first row of images of the first set of images, the first row of images disposed in sequence along the second axis perpendicular to the first axis;
identifying, responsive to detecting the code, a second row of images of the first set of images, the second row of images disposed in sequence along the second axis;
combining, along the second axis, the first row of images into a first combined row image of the first set of combined images;
combining, along the second axis, the second row of images into a second combined row image of the first set of combined images.

3. The method of claim 2, wherein combining, along the first axis, the first set of rotated images into the first partial item image comprises:
identifying a first row of rotated images of the first set of rotated images, the first row of rotated images disposed along the second axis;
identifying a second row of rotated images of the first set of rotated images, the second row of rotated images disposed along the second axis;
combining, along the second axis, the first row of rotated images and the second row of rotated images into the first partial item image.

4. The method of claim 1, further comprising:
receiving, responsive to detecting the code, a second set of images of the item from a second set of camera sources, the item traversing beneath the second set of camera sources along the first axis;
combining, along the second axis perpendicular to the first axis, the second set of images into a second set of combined images;
rotating, parallel to the first axis, each of the second set of combined images into a second set of rotated images; and
combining, along the first axis, the second set of rotated images into a second partial item image.

5. The method of claim 4, wherein combining, along the second axis perpendicular to the first axis, the second set of images into the second set of combined images comprises:
identifying, responsive to detecting the code, a third row of images of the second set of images, the third row of images disposed in sequence along the second axis perpendicular to the first axis;
identifying a fourth row of images of the second set of images, the fourth row of images disposed in sequence along the second axis;
combining, along the second axis, the third row of images into a third combined row image of the second set of combined images;
combining, along the second axis, the fourth row of images into a fourth combined row image of the second set of combined images.

6. The method of claim 5, wherein combining, along the first axis, the first set of rotated images into the second partial item image comprises:
identifying a third row of rotated images of the second set of rotated images, the third row of rotated images disposed along the second axis;
identifying, a fourth row of rotated images of the second set of rotated images, the fourth row of rotated images disposed along the second axis;
combining, along the second axis, the third row of rotated images and the fourth row of rotated images into the second partial item image.

7. The method of claim 4, further comprising:
combining the first partial item image and the second partial item image into an item image;
identifying an ideal image from an image database, the ideal image corresponding to the code;
extracting an ideal image parameter from the ideal image;
extracting an item image parameter from the item image;
generating a correlation score between the item image and the ideal image by comparing the item image parameter to the ideal image parameter; and
transmitting, responsive to the correlation score satisfying a predetermined correlation threshold, the item image to a server.

8. The method of claim 7, wherein transmitting, responsive to the correlation score satisfying the predetermined correlation threshold, the item image to the server comprises:
extracting, responsive to the correlation score satisfying the predetermined correlation threshold, a sectional image parameter corresponding to an item image section of the item image;
comparing, the sectional image parameter to the ideal image parameter to generate a sectional correlation score of the item image section; and
transmitting, to the server, the item image section having the sectional correlation score satisfying a predetermined sectional correlation score.

9. The method of claim 1, further comprising:
receiving, a set of calibration images of a calibration item from the first set of camera sources, the calibration item having a predetermined calibration parameter; and
calibrating, the combining and the rotating based on the predetermined calibration parameter.

10. A non-transitory computer-readable storage medium having instructions embodied thereon, the instructions being executable by one or more processors to perform a method for scanning items at the point of manufacturing, the method comprising:
receiving a first set of images of an item from a first set of camera sources, the item traversing beneath the first set of camera sources along a first axis;
detecting a code in the first set of images, the code having a unique item identifier;
combining, responsive to detecting the code, along a second axis perpendicular to the first axis, the first set of images into a first set of combined images;
rotating parallel to the first axis, each of the first set of combined images into a first set of rotated images; and
combining along the first axis, the first set of rotated images into a first partial item image.

11. The computer-readable storage medium of claim 10, wherein combining, responsive to detecting the code, along the second axis perpendicular to the first axis, the first set of images into the first set of combined images comprises identifying, responsive to detecting the code, a first row of images of the first set of images, the first row of images disposed in sequence along the second axis perpendicular to the first axis;
wherein combining, responsive to detecting the code, along the second axis perpendicular to the first axis, the first set of images into the first set of combined images comprises identifying, responsive to detecting the code, a second row of images of the first set of images, the second row of images disposed in sequence along the second axis;
wherein combining, responsive to detecting the code, along the second axis perpendicular to the first axis, the first set of images into the first set of combined images comprises combining, along the second axis, the first row of images into a first combined row image of the first set of combined images;
wherein combining, responsive to detecting the code, along the second axis perpendicular to the first axis, the first set of images into the first set of combined images comprises combining, along the second axis, the second row of images into a second combined row image of the first set of combined images.

12. The computer-readable storage medium of claim 11, wherein combining, along the first axis, the first set of rotated images into the first partial item image comprises identifying a first row of rotated images of the first set of rotated images, the first row of rotated images disposed along the second axis;
wherein combining, along the first axis, the first set of rotated images into the first partial item image comprises identifying a second row of rotated images of the first set of rotated images, the second row of rotated images disposed along the second axis;
wherein combining, along the first axis, the first set of rotated images into the first partial item image comprises combining, along the second axis, the first row of rotated images and the second row of rotated images into the first partial item image.

13. The computer-readable storage medium of claim 10, wherein the method further comprises:
receiving, responsive to detecting the code, a second set of images of the item from a second set of camera sources, the item traversing beneath the second set of camera sources along the first axis;
combining, along the second axis perpendicular to the first axis, the second set of images into a second set of combined images;
rotating, parallel to the first axis, each of the second set of combined images into a second set of rotated images; and
combining, along the first axis, the second set of rotated images into a second partial item image.

14. A system configured for scanning items at the point of manufacturing, the system comprising:
means for receiving a first set of images of an item from a first set of camera sources, the item traversing beneath the first set of camera sources along a first axis;
means for detecting a code in the first set of images, the code having a unique item identifier;
means for combining, responsive to detecting the code, along a second axis perpendicular to the first axis, the first set of images into a first set of combined images;
means for rotating parallel to the first axis, each of the first set of combined images into a first set of rotated images; and
means for combining along the first axis, the first set of rotated images into a first partial item image.

15. The system of claim 14, wherein combining, responsive to detecting the code, along the second axis perpendicular to the first axis, the first set of images into the first set of combined images comprises identifying, responsive to detecting the code, a first row of images of the first set of images, the first row of images disposed in sequence along the second axis perpendicular to the first axis;
wherein combining, responsive to detecting the code, along the second axis perpendicular to the first axis, the first set of images into the first set of combined images comprises identifying, responsive to detecting the code, a second row of images of the first set of images, the second row of images disposed in sequence along the second axis;
wherein combining, responsive to detecting the code, along the second axis perpendicular to the first axis, the first set of images into the first set of combined images comprises combining, along the second axis, the first row of images into a first combined row image of the first set of combined images;
wherein combining, responsive to detecting the code, along the second axis perpendicular to the first axis, the first set of images into the first set of combined images comprises combining, along the second axis, the second row of images into a second combined row image of the first set of combined images.

16. The system of claim 15, wherein combining, along the first axis, the first set of rotated images into the first partial item image comprises identifying a first row of rotated images of the first set of rotated images, the first row of rotated images disposed along the second axis;
wherein combining, along the first axis, the first set of rotated images into the first partial item image comprises identifying a second row of rotated images of the first set of rotated images, the second row of rotated images disposed along the second axis;
wherein combining, along the first axis, the first set of rotated images into the first partial item image comprises combining, along the second axis, the first row of rotated images and the second row of rotated images into the first partial item image.

17. The system of claim 14, further comprising:
means for receiving, responsive to detecting the code, a second set of images of the item from a second set of camera sources, the item traversing beneath the second set of camera sources along the first axis;
means for combining, along the second axis perpendicular to the first axis, the second set of images into a second set of combined images;
means for rotating, parallel to the first axis, each of the second set of combined images into a second set of rotated images; and
means for combining, along the first axis, the second set of rotated images into a second partial item image.

18. A computing platform configured for scanning items at the point of manufacturing, the computing platform comprising:
a non-transient computer-readable storage medium having executable instructions embodied thereon; and
one or more hardware processors configured to execute the instructions to:
receive a first set of images of an item from a first set of camera sources, the item traversing beneath the first set of camera sources along a first axis;
detect a code in the first set of images, the code having a unique item identifier;
combine, responsive to detecting the code, along a second axis perpendicular to the first axis, the first set of images into a first set of combined images;
rotate parallel to the first axis, each of the first set of combined images into a first set of rotated images; and
combine along the first axis, the first set of rotated images into a first partial item image.

19. The computing platform of claim 18, wherein combining, responsive to detecting the code, along the second axis perpendicular to the first axis, the first set of images into the first set of combined images comprises identifying, responsive to detecting the code, a first row of images of the first set of images, the first row of images disposed in sequence along the second axis perpendicular to the first axis;
wherein combining, responsive to detecting the code, along the second axis perpendicular to the first axis, the first set of images into the first set of combined images comprises identifying, responsive to detecting the code, a second row of images of the first set of images, the second row of images disposed in sequence along the second axis;
wherein combining, responsive to detecting the code, along the second axis perpendicular to the first axis, the first set of images into the first set of combined images comprises combining, along the second axis, the first row of images into a first combined row image of the first set of combined images;
wherein combining, responsive to detecting the code, along the second axis perpendicular to the first axis, the first set of images into the first set of combined images comprises combining, along the second axis, the second row of images into a second combined row image of the first set of combined images.

20. The computing platform of claim 19, wherein combining, along the first axis, the first set of rotated images into the first partial item image comprises identifying a first row of rotated images of the first set of rotated images, the first row of rotated images disposed along the second axis;
wherein combining, along the first axis, the first set of rotated images into the first partial item image comprises identifying a second row of rotated images of the first set of rotated images, the second row of rotated images disposed along the second axis;
wherein combining, along the first axis, the first set of rotated images into the first partial item image comprises combining, along the second axis, the first row of rotated images and the second row of rotated images into the first partial item image.

21. The computing platform of claim 20, wherein the one or more hardware processors are further configured by the instructions to:
receive, responsive to detecting the code, a second set of images of the item from a second set of camera sources, the item traversing beneath the second set of camera sources along the first axis;
combine, along the second axis perpendicular to the first axis, the second set of images into a second set of combined images;
rotate, parallel to the first axis, each of the second set of combined images into a second set of rotated images; and
combine, along the first axis, the second set of rotated images into a second partial item image.
